(19) United States
(12) Patent Application Publication
(10) Pub. No.: US 2022/0318621 A1
(43) Pub. Date: Oct. 6, 2022

(54) Optimised Machine Learning

(71) Applicant: Vision Semantics Limited, London (GB)

(72) Inventors: Shaogang Gong, London (GB); Zimo Liu, Liaoyang (CN)

(21) Appl. No.: 17/618,310

(22) PCT Filed: Jun. 12, 2020
(86) PCT No.: PCT/GB2020/051420

§ 371 Date: Dec. 10, 2021

(30) Foreign Application Priority Data
Jun. 14, 2019 (GB) 1908574.5

(51) Int. Cl. G06N 3/08

(52) U.S. Cl. CPC G06N 3/08

(57) ABSTRACT

Method for optimising a reinforcement learning model comprising the steps of receiving a labelled data set. Receiving an unlabelled data set. Generating model parameters to form an initial reinforcement learning model using the labelled data set as a training data set. Finding a plurality of matches for one or more target within the unlabelled data set using the initial reinforcement learning model. Ranking the plurality of matches. Presenting a subset of the ranked matches and corresponding one or more target, wherein the subset of ranked matches includes the highest ranked matches. Receiving a signal indicating that one or more presented match of the highest ranked matches is an incorrect match. Adding information describing the indicated incorrect one or more match and corresponding target to the labelled data set to form a new training data set. Updating the model parameters of the initial reinforcement learning model to form an updated reinforcement learning model using the new training data set.

### FIELD OF THE INVENTION

The present invention relates to a system and method for optimising a reinforcement learning model and in particular, for use with computer vision and image data. This may also be described as Localised Machine Learning Optimisation.

### BACKGROUND OF THE INVENTION

The success of deep learning in computer vision and other fields in recent years has relied heavily upon the availability of large quantities of labelled training data. However, there are two emerging fundamental challenges to deep learning: (1) How to scale up model training on large quantities of unlabelled data from a previously unseen application domain (target domain) given a previously trained model from a different domain (source domain); and (2) How to scale up model training when different target domain application data are no longer available to a centralised data labelling and model training process due to privacy concerns and data protection requirements. For deep learning on person re-identification (Re-ID) tasks in particular, most existing person Re-ID techniques are based on the assumption that a large amount of pre-labelled data is available and can be used for model training all at once in batch. However, this assumption is not applicable to most real-world deployment of a Re-ID system.

For example, it is difficult for different systems or organisations may be unwilling to share their data, whereas successful and improved model training relies on larger training sets. In some situations, supervised learning can improve the situation but this relies on human users to confirm results provided by the trained model. This is time consuming and can be unfeasible for larger data sets.

Therefore, there is required a method and system that provides an improved, more efficient and more effective way to carry out localised model training without overburdening human users or required larger labelled data sets.

### SUMMARY OF THE INVENTION

The following machine learning methods and mechanisms to implement two complementary aspects of distributed AI deep learning at-the-edge (each private user-site, e.g. a target application domain without requiring the sharing of data, or on an AI device, e.g. AI chip). These two aspects may be used independently or in combination.

Locally for each user-site application (application target domain), deep reinforcement learning is implemented based on a human-in-the-loop data mining model to remove the need for a strong model trained on globally collected labelled training data of a large size. Instead, a weak model, pre-trained by independent small sized labelled data (non-target domain) is activated at each user-site for deployment (user-usage) and simultaneously performs local (per user-site) online model optimisation by cumulatively collecting informative samples from using the pre-trained weak model without exhaustively labelling all the data at every user-site to collect a large global training data pool. This model reduces human annotation by machine-guided selective data sampling for locally (distributed at-the-edge) optimised models at each and different application target domain according to its unique environmental context. This avoids the need for globally sharing training data across different application target domains to learn a strong model, so to comply with data protection and privacy preserving at each individual application domain.

In an example implementation a framework is iteratively updated by refining a Reinforcement Learning (RL) policy and Convolutional Neural Network (CNN) parameters alternately. In particular, a Deep Reinforcement Active Learning (DRAL) method is formulated to guide an agent (a model in a reinforcement learning process) in selecting training samples to be reviewed by human user who can provide “weak” feedback by confirming model generated predictions according to a ranked likelihood. The reinforcement learning reward is the uncertainty value of each human confirmation for each selected sample. A binary feedback (positive or negative) given by the human annotator and used to select the samples, which are then used to optimise iteratively (multiple times) a pre-trained CNN Re-ID model locally at each user-site by cumulative model fine tuning against collections of newly sampled data (unlabelled) using reinforcement deep learning. This distributed AI reinforcement model may be described as optimisation at-the-edge.

Globally, a mechanism enables distributed AI reinforcement model optimisation at-the-edge to also share global knowledge from multiple application target domains by knowledge ensemble and distillation through multi-model representation alignment and cumulation without sharing global training data. In particular, a knowledge distillation mechanism provides cumulate knowledge from distributed model learning at multiple domains. This results in a strong teacher model for knowledge ensemble and distillation by constructing a multi-branch deep network model, where each model branch captures a pre-learned model representation from a different user-domain with different training data while simultaneously learning the strong teacher model and providing enhanced model representation to each target domain. This may be described as global AI knowledge ensemble and distillation through model representation without sharing different target domain (user-site) training data.

Overall, this approach to this distributed AI deep model learning at-the-edge is designed to facilitate distributed model optimisation given partial (local) relatively small data that only requires limited computing resources (e.g. without hyperscale data centres), of which an extreme case is deep learning on embedded AI chips built into a new generation of body-worn smart cameras and mobile devices, e.g. ARM ML Processor and OD Processor, Nvidia Jetson TX2 GPU, and Google Edge TPU. This distributed AI deep model learning mechanism facilitates privacy-preserving AI for user-centred services whilst simultaneously cumulating globally knowledge from distributed AI model learning without global data sharing. This has become essential for empowering the rapid emergence of new AI chip technologies for large scale distributed user-cantered applications with user-cantered data ownership and privacy protection being essential to such distributed AI systems.

In accordance with a first aspect there is provided a method for optimising a reinforcement learning model comprising the steps of:

receiving a labelled data set;

receiving an unlabelled data set;

generating model parameters to form an initial reinforcement learning model using the labelled data set as a training data set;

finding a plurality of matches for one or more target within the unlabelled data set using the initial reinforcement learning model;

ranking the plurality of matches;

presenting a subset of the ranked matches and corresponding one or more target, wherein the subset of ranked matches includes the highest ranked matches;

receiving a signal indicating that one or more presented match of the highest ranked matches is an incorrect match;

adding information describing the indicated incorrect one or more match and corresponding target to the labelled data set to form a new training data set; and

updating the model parameters of the initial reinforcement learning model to form an updated reinforcement learning model using the new training data set. Therefore, the reinforcement learning model can be improved more efficiently and improving the effectiveness of human review. This localised model training improves the overall performance of the method and system. The method may be implemented as a system or distributed system, for example.

Advantageously, the subset of ranked matches further includes the lowest ranked matches, and before updating the model parameters of the initial reinforcement model, the method further comprising the steps of:

receiving a signal indicating that one or more presented match of the lowest ranked matches is a correct match; and

adding information describing the indicated correct one or more match and corresponding target to the new training data set. Whilst limiting the matches to the best matches provides an improvement (especially when incorrect matches amongst this group are detected and incorporated into the training set) alternatively, or additionally, matches from the lower or lowest ranking may be passed for review by the human user. Whilst receiving confirmation that such lower matches are not actual matches (and this can go some way to improving the model) receiving information confirming a match where it is not expected amongst the lowest ranked matches provides a significant boost to the training of the model when such information is included in the training data set. Doing both is especially useful and effective.

Optionally, wherein the unlabelled data set is larger than the labelled data set.

Optionally, the method may further comprise the steps of:

finding a plurality of new matches for one or more new target within the unlabelled data set using the updated reinforcement learning model;

ranking the plurality of new matches;

presenting a subset of the ranked new matches and corresponding one or more target, wherein the subset of ranked matches includes the highest ranked matches;

receiving a signal indicating that one or more presented match of the highest ranked new matches is an incorrect match;

adding information describing the indicated one or more incorrect new match and corresponding new target to the labelled data set to form a further new training data set; and

updating the model parameters of the initial reinforcement learning model to form an updated reinforcement learning model using the further new training data set. This defines a first iteration.

Optionally, the subset of ranked new matches may further include the lowest ranked new matches, and before updating the model parameters of the updated reinforcement model, the method may further comprise the steps of:

receiving a signal indicating that one or more presented new match of the lowest ranked new matches is a correct match; and

adding information describing the indicated correct one or more new match and corresponding target to the further new training data set. This may be done as part of the first iteration.

Optionally, the method may further comprise iterating the finding, ranking, presenting, receiving and updating steps for one or more further targets to further update the reinforcement learning model each iteration. Such iterations may continue until a criteria is reached (e.g. time, number of iterations, etc.)

Optionally, the one or more new target is a different target to an earlier one or more target. The matches presented to the human user may be for a single target or for several different targets. The target or targets may change, for different iterations or may stay the same.

Optionally, the step of updating the model parameters of the reinforcement learning model may further comprise:

finding a maximised reward applied to an action sequence used to update the model parameters of the initial reinforcement learning model.

Preferably, the reward, R, may be defined by:

$${R}_{t} = {[ m + {y}_{k}^{t} ( {max}_{{x}_{i} ∈ {X}_{p}^{t}} {d}_{{g}_{k}}^{{x}_{i}} - {min}_{{x}_{j} ∈ {X}_{n}^{t}} {d}_{{g}_{k}}^{{x}_{j}} ) ]}_{+}$$

where Xₚ^{t}, Xₙ^{t} are positive and negative sample batches obtained until time t, d_{g}_{ₖ}^{x} is a function of a Mahalanobis distance between any two samples gₖ and x, and [•]₊ is a soft margin function by at least a margin m.

Preferably, the method may further comprise the step of maximising Q* according to:

$${Q}^{*} = {max}_{π} 𝔼 [ {R}_{t} + γ {R}_{t + 1} + {γ}^{2} {R}_{t + 2} ⋯ \vert π , {S}_{t} , {A}_{t} ]$$

for all future rewards (Rₜ₊₁, Rₜ₊₂, . . . ) discounted by a factor γ to find an optimal policy π* used to update the model parameters of the reinforcement learning model. Other techniques may be used.

Optionally, the method may further comprise the step of forming a new reinforcement learning model by combining model parameters of the updated reinforcement learning model with a different updated reinforcement learning model that was generated using a different unlabelled data set. Therefore, models that are trained from different (private) data sets may be fused without having to merge the data.

Optionally, the labelled data set and the unlabelled data set are image data sets, natural language data sets, or geo-location data sets. Other data sets and types may be used.

Optionally, presenting the subset of the matches and corresponding one or more target and receiving the signal may further comprise presenting to a user an image of the target and an image matched with the target and receiving a true response from the user when the user determines a match and a false response from the user determines that the images don't match.

Preferably, the initial and new reinforcement learning models may be generated using a convolutional neural network architecture.

Advantageously, ranking the plurality of matches may be based on:

a softmax Cross Entropy loss function:

$${L}_{corss} = - \frac{1}{{n}_{b}} {\sum }_{i = 1}^{{n}_{b}} log ( {p}_{i} ( y ) )$$

where n_{b} is a batch size and pᵢ(y) is a predicted probability on a ground-truth class y of an input target and a triplet loss is defined by:

$${L}_{tri} = {\sum }_{{x}_{a} , {x}_{p} , {x}_{n}}^{{n}_{b}} [ {D}_{{x}_{a} , {x}_{p}} - {D}_{{x}_{a} , {x}_{n}} + m ]$$

where m is a margin parameter for positive and negative pairs for triplet samples xₐ being an anchor point, xₚ being a hardest positive sample, and xₙ being a negative sample of a different class to xₐ, where the loss is calculated from:

Lₜₒₜₐₗ=L_{cross}+Lₜᵣᵢ.

Optionally, the method according to any previous claim may further comprise the step of selecting matches to present as the subset of matches.

Preferably, the subset of matches may be selected by building a sparse similarity graph based on a similarity value Sim(i,j) between two samples i, j calculated from

$$Sim ( i , j ) = 1 - \frac{{d}_{i}^{j}}{{max}_{i , j ∈ q , g} {d}_{i}^{j}}$$

where q is the target and g={g₁, g₂, . . . , gₙ_{ₛ}} is the plurality of matches for the target, nₛ is a pre-defined number of matches, and dᵢ^{j} is a Mahalanobis distance of i,j.

Optionally, the method may further comprise the step of executing a k-reciprocal operation to build the sparse similarity matrix having nodes nᵢϵ(q, g), where k-nearest neighbour are defined as N(nᵢ,k), and k-reciprocal neighbours R(nᵢ,k) of ni are obtained by:

R(nᵢ,κ)={xⱼ|(nᵢϵN(xⱼ,κ))\hat{ }(xⱼϵN(nᵢ,κ))}.

Optionally, the method may further comprise the step of merging the parameters of the updated reinforcement learning model with parameters of a different updated reinforcement learning model trained using a different unlabelled training data set, to form a further cumulation of distributed reinforcement learning models.

In accordance with a second aspect, there is provided a method for optimising a reinforcement learning model comprising the steps of:

receiving from a first node, first model parameters of a first reinforcement learning model, the first reinforcement learning model trained using a first labelled data set and a first unlabelled data set as training data sets;

receiving from a second node, second model parameters of a second reinforcement learning model, the second reinforcement learning model trained using a second labelled data set and a second unlabelled data set as training data sets; and

merging the first and second model parameters to define a further reinforcement learning model. This allows models to be fused or merged without requiring access to different data sets at the same time. This aspect can be used with any of the above aspects or used with models trained in different ways.

Optionally, the first labelled data set same is the second labelled data set.

Optionally, the method may further comprise the steps of:

receiving from one or more further nodes, one or more further model parameters of one or more further reinforcement learning models, the one or more further reinforcement learning models trained using one or more further labelled data sets and one or more further unlabelled data sets as training data sets; and

merging the first, second and one or more further model parameters to define a further cumulation of distributed reinforcement learning models. Accumulating reinforcement learning models in this way provides an improved and more efficient result.

Optionally, the method may further comprise the step of sending the merged first and second model parameters to the first and second nodes. Two or more nodes may be used or benefit in this way.

Optionally, the method may further comprise the step of the first and second and second nodes using the further reinforcement model defined by the merged first and second model parameters to identify target matches within unlabelled data sets.

Preferably, the first and second model parameters may be merged by computing a soft probability distribution at a temperature T according to:

$${\tilde{p}}_{i} ( c \vert x , {θ}^{i} ) = \frac{exp ( {z}_{i}^{c} / T )}{{\sum }_{j = 1}^{C} exp ( {x}_{i}^{j} / T )} , c ∈ 𝒴 \\ {\tilde{p}}_{e} ( c \vert x , {θ}^{e} ) = \frac{exp ( {z}_{e}^{c} / T )}{{\sum }_{j = 1}^{C} exp ( {z}_{e}^{j} / T )} , c ∈ 𝒴$$

where i denotes a branch index, i=0, m, θⁱ and θ^{e} are the parameters of a branch and teacher model, respectively. Other merging functions may be used.

Preferably, the method may further comprise the step of aligning model representations between branches using a Kullback Leibler divergence defined by:

$${ℒ}_{kl} = {\sum }_{i = 0}^{m} {\sum }_{j = 1}^{C} {\tilde{p}}_{e} ( j \vert x , {θ}^{e} ) log \frac{{\tilde{p}}_{e} ( j \vert x , {θ}^{e} )}{{\tilde{p}}_{i} ( j \vert x , {θ}^{i} )}$$

In accordance with a third aspect, there is provided a data processing apparatus, computer or computer system comprising one or more processors adapted to perform the steps of any of the above methods.

In accordance with a fourth aspect, there is provided a computer program comprising instructions, which when executed by a computer, cause the computer to carry out any of the above methods.

In accordance with a fifth aspect, there is provided a computer-readable medium comprising instructions, which when executed by a computer, cause the computer to carry out any of the above methods.

The methods described above may be implemented as a computer program comprising program instructions to operate a computer. The computer program may be stored on a computer-readable medium.

The computer system may include a processor or processors (e.g. local, virtual or cloud-based) such as a Central Processing unit (CPU), and/or a single or a collection of Graphics Processing Units (GPUs). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows® or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a flow chart of a method for optimising a reinforcement learning model, including presenting matches to a human user;

FIG. 2 shows a schematic diagram of a system in which the human user confirms the matches presented in FIG. 1;

FIG. 3 shows a schematic diagram of a further method and system for optimising a reinforcement learning model by merging different models;

FIG. 4 shows schematic diagram of a system for implementing the method of FIG. 1;

FIG. 5 shows a schematic diagram of the system of FIG. 2 in more detail;

FIG. 6 shows graphical results of the system of FIGS. 2 and 5 when tested with different data sets; and

FIG. 7 shows example images used in the data sets of FIG. 6.

It should be noted that the figures are illustrated for simplicity and are not necessarily drawn to scale. Like features are provided with the same reference numerals.

### DETAILED DESCRIPTION OF THE PREFERRED EMBODIMENTS

Large-scale visual object recognition (in particular people and vehicles) in urban spaces has become a major focus for Artificial Intelligence (AI) research and technology development with rapid growth in commercial applications. There is a fundamental technological challenge and market opportunity driven by economical needs to develop scalable machine learning algorithms and software for large-scale visual recognition in urban spaces by exploring the huge quantity of video data using deep learning, critical for smart city, public safety, intelligent transport, urban planning and design, e.g. Alibaba's City Brain; smart shopping, e.g. Amazon Go; and the fast-emerging self-driving cars. People and vehicle visual identification and search on urban streets at city-wide scales is a difficult task but potentially can revolutionise future smart city design and management, a technology that has not been considered scalable only until the recent emergence and rapid adaptation of deep learning, enabled by two advances in recent years: (1) The availability of very large-sized and labelled imagery data for model training, and (2) the rise of cheap, widely accessible and powerful Graphics Processing Unit (GPU) for AI model learning, originally designed for the computer games industry, most notably the Nvidia GPUs. Over the last decade, there has been a huge amount of video data captured from 24/7 urban camera infrastructures (camera networks on the roads, transport hubs, shopping malls), social media (e.g. YouTube, Flickr), and increasingly more from mobile platforms (mobile phones, cameras on vehicle dashboards and body-worn cameras). However, the vast majority of visual data are unstructured and unlabelled.

The following examples describe image and video data sets where individual people with such images are targets. The aim is to identify the same people in different locations obtained by separate video and image feeds. However, the described system and method may also be applied to different data sets, especially where targets are identified in from separate sources.

The incredible success of deep learning in computer vision, text analysis, speech recognition, and natural language processing in recent years relies heavily upon the availability of large quantities of labelled training data. Deep neural network learning assumes fundamentally that (1) a large volume of data can be collected from multi-source domains (diversity), stored on a centralised database for model training (quantity), (2) human resources are available for exhaustive manual labelling of this large pool of shared training data (human knowledge distillation).

However, there are two emerging fundamental challenges to deep learning: (1) How to scale up model training on large quantities of unlabelled data from a previously unseen application domain (target domain) given a previously trained model from a different domain (source domain); (2) How to scale up model training when different target domain user application data are no longer available to a centralised data labelling and model training process due to privacy concerns and data protection requirements, e.g. the EU-wide adoption of the General Data Protection Regulation (GDPR) in 2018. Despite the current significant focus on centralised data centres to facilitate big data machine learning drawing from shared data collection interfaces (multiple users), e.g. cloud-based robotics, the world is moving increasingly towards localised and private (not-shared) distributed data analysis at-the-edge, which differs inherently from the current assumption of ever-increasing availability of centralised big data and shared data analysis. The existing centralised and shared big data learning paradigm faces significant challenges when privacy concerns become critical, e.g. large-scale public domain people recognition for public safety and smart city, healthcare patient data analysis for personalised healthcare. This requires fundamentally a new kind of deep learning paradigm, what may be called user-ensuite (privacy-preserving) human-in-the-loop distributed data mining for deep learning at-the-edge. This new type of deep learning at-the-edge protects user data privacy whilst increasing model capacity cumulatively so to benefit all users without sharing data, by assembling user knowledge distributed through localised deep learning from user-ensuite data mining. This emerging need for distributed deep learning by knowledge ensemble at each user site without global data sharing poses new and fundamental challenges to current algorithm and software designs. Deep learning at-the-edge requires a model design that can facilitate effective model adaptation to partial (local) relatively small data sets (compared with deep learning principles) on limited computing resources (without hyperscale data centres). In an extreme case, this may be deep learning using embedded AI chips built into a new generation of body-worn smart cameras and mobile devices, e.g. ARM ML Processor and OD Processor, Nvidia Jetson TX2 GPU, and Google Edge TPU. Currently, there is very little if any research and development for methods and processes to enable such an AI deep learning at-the-edge paradigm.

Mechanisms for distributed AI deep learning at-the-edge are provided by exploring human-in-the-loop reinforcement data mining at a user site, with a particular focus on optimising person re-identification tasks, although the underlying methodology and processes are readily applicable to wider deep learning at-the-edge applications and system deployments, especially for other data sources.

In one example, person re-identification (Re-ID) matches people across non-overlapping camera views distributed at distinct locations. Most existing supervised person Re-ID approaches employ a train-once-and-deploy scheme. This may be pairwise training data that are collected and annotated manually for every pair of cameras before learning a model. Based on this assumption, supervised deep learning based Re-ID methods have made a significant progress in recent years [27, 80, 53, 75, 41].

However, in practice this assumption is not easy to adapt due several reasons: Firstly, pairwise pedestrian data is difficult to collect since it is unlikely that a large number of pedestrians reappear in other camera views. Secondly, the increasing number of camera views amplifies the difficulties in searching for the same person among multiple camera views. Thirdly, and perhaps most critically, increasingly less user data will be made available for a global training data collection limiting the availability of a centralised manual labelling process which is essential for enabling deep learning, due to privacy and data protection concerns. To address these difficulties, one solution is to design unsupervised learning algorithms where centralised manual labelling of training data is not required. Some work has been focussed on transfer learning or domain adaption technique for unsupervised Re-ID [16, 64, 44]. However, unsupervised learning based Re-ID models are inherently weaker compared to supervised learning based models, compromising Re-ID effectiveness in any practical deployment.

Another possible solution is following the semi-supervised learning scheme that decreases the requirement of data annotations. Successful research has been done on either dictionary learning [43] or self-paced learning [18] based methods. These models are still based on a strong assumption that parts of the identities (e.g. one third of the training set) are fully labelled for every camera view. This remains impractical for a Re-ID task with hundreds of cameras obtained from 24/7 operation, which is typical in urban applications.

Both unsupervised and semi-supervised model training still assume the accessibility of large quantity of raw (unlabelled) data from diverse user sites. This has become increasingly less plausible due to privacy concerns. To achieve effective Re-ID given a limited budget for annotation (data labelling) and limited data access in the first place, the present method focusses on human-in-the-loop person Re-ID with selective labelling by human feedback online [63]. This approach differs from the common once-and-done model learning approach. Instead, a step-by-step sequential active learning process is adopted by exploring human selective annotations on a much smaller pool of samples for model learning. These cumulatively human-labelled data (binary verification) are used to update model training for improved Re-ID performance. Such an approach to model learning is naturally suited for reinforcement learning together with active learning.

Active learning is a technique for online human data annotation that aims to sample actively the more informative training data for optimising model learning without exhaustive data labelling. Therefore, the benefit from human involvement is increased without requiring significantly more manual review time. This involves selecting from an unlabelled set matches that are generated by using an initially trained model. These potential matches are then annotated by a human oracle (user), and the label information provided by the user is then employed for further model training. Preferably, these operations repeat many times until a termination criterion is satisfied, e.g. the annotation budget is exhausted. An important part of this process is the sample selection strategy. Some samples and annotations have a greater (positive) effect on model training than other. Ideally, more informative samples are reviewed requiring less human annotation cost, which improves overall performance of the system. Rather than a hand-design strategy, the present system provides a reinforcement learning-based criterion.

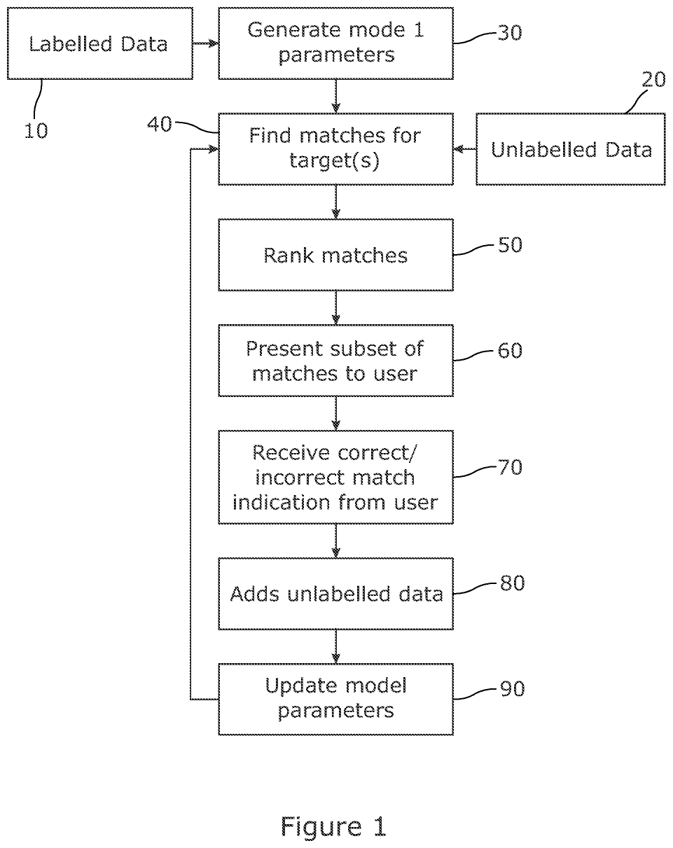

FIG. 1 shows a flow chart of a method 10 for optimising a reinforcement learning model. Labelled data 10 and unlabelled data 20 are provided. The labelled data 10 is used as an initial training data set to generate (or update) model parameters of the reinforcement learning model at step 30. Using the model training using the labelled data 10, the matches are found against one or more targets within the unlabelled data 20. These matches are ranked at step 50. Various techniques may be used to rank the matches are examples are provided below.

At step 60 a subset of these matches are presented to the human user. The matches comprise a target image and one more possible matches. Not all of the matches are required and the subset includes the higher or highest ranked results. These results are those with the greatest confidence that the matches are correct. However, they may still contain incorrect matches. In some implementations, lower or the lowest ranked matches are also presented. These are typically the matches with the lowest reliability or confidence. Therefore, the system considers these to be incorrect matches. Thresholds may also be used to determine which matches to include in the subset.

At step 70 the human user reviews the presented matches (to particular targets) and either confirms the match or indicates an incorrect match. This can be a binary signal obtained by a suitable user interface (e.g. mouse click, keystroke, etc.). These results relate to the originally unlabelled data, but which have now been annotated by the human user. These (reviewed) unlabelled data together with the indications of matches to particular targets are added to the labelled data to provide a new training data set at step 80. This updated training data set is use to update the model parameters of the reinforcement learning model at step 90. Whilst this method 10 provides an enhanced model, iterating the steps one or more times provides additional enhancements. The loop may end when a particular criteria is met.

In particular embodiments, it is the indications of incorrect matches for the higher or highest ranked matches and/or the indications of correct matches for the lower or lowest ranked matches. Therefore, in some implementations, only these data are added to form the new training data set. In any case, restricting the matches to the highest and/or lowest ranked matches improves model training as there will be proportionally more of these type of results, whilst reducing the amount of work or time required by a human user 110.

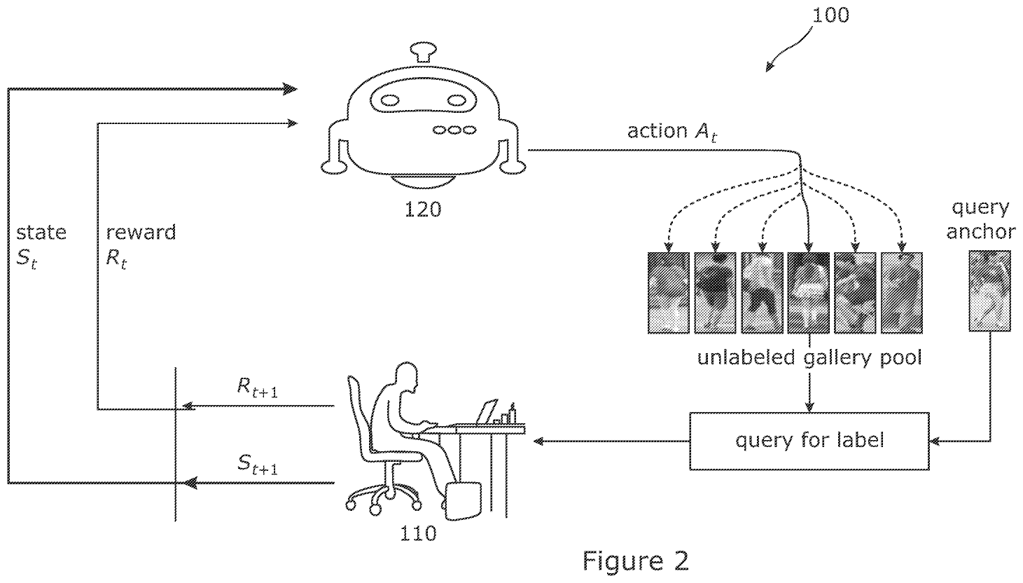

FIG. 2 illustrates an example system 100 for a Deep Reinforcement Active Learning (DRAL) model. For each query anchor (probe), an agent 120 (reinforcement learning model) will generate sequential instances for human annotation by binary feedback (positive/negative) in an active learning process. A reinforcement learning policy enables active selection of new training data from a large pool of unlabelled test data using human feedback. A Convolutional Neural Network (CNN) model introduces both active learning (AL) and reinforcement learning (RL) in a single human-in-the-loop model learning framework. By representing the AL part as a sequence making process, each action affects the sample correlations among the unlabelled data pool (with similarity re-computed at each step). This influences the decision at the next step. By treating the uncertainty brought by the selected samples as the objective goal, the RL part of the model aims to learn a powerful sample selection strategy given human feedback annotations. Therefore, the informative samples selected from the RL policy significantly boost the performance of Re-ID which in return enhances sample choosing strategy. Applying an iterative training scheme leads to a stronger Re-ID model.

An AI knowledge ensemble and distillation method is also provided. This not only is more efficient (lower training cost) but is also more effective (higher model generalisation improvement). In knowledge ensemble, this method constructs a multi-branch strong model consisting of multiple weak target models of the same model architecture (therefore a shared model representation) with different model representation instances (e.g. different deep neural network instances of the same architecture initialised by different pre-training on different data from different target domains). This creates a knowledge ensemble “teacher model” from all of the branches, and enhances/improves simultaneously each branch together with the teacher model. Therefore, separate data sets can be used to enhance a model used by different systems without having to share data.

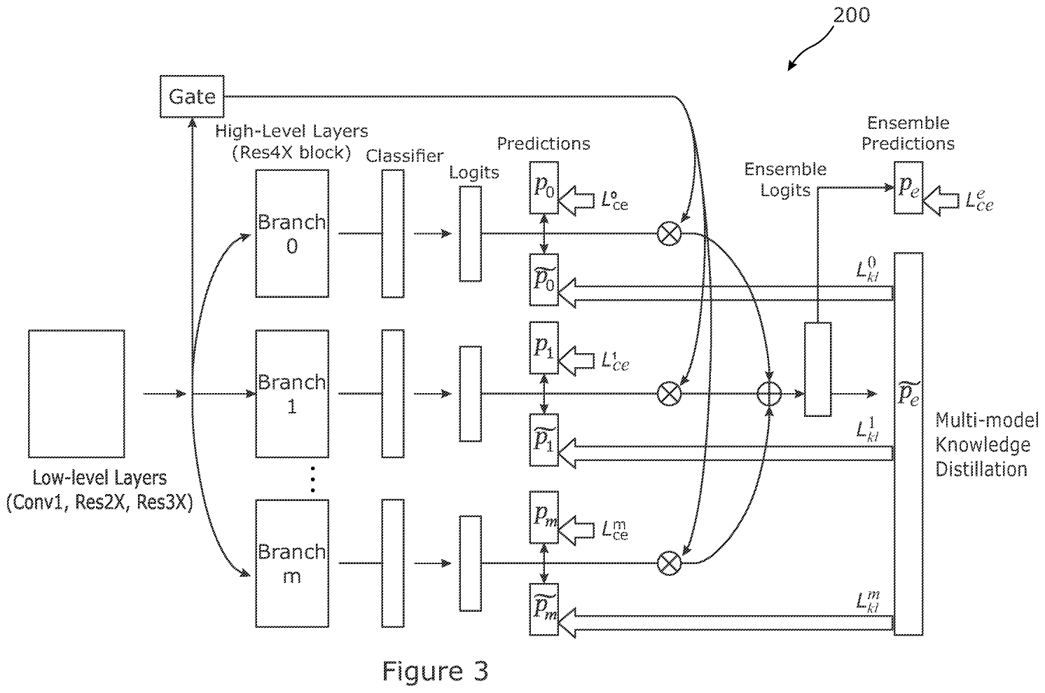

Each branch is trained with two objective loss terms: A conventional softmax cross-entropy loss which matches with the ground-truth label distributions, and a distillation loss which aligns the model representation of each branch to the teacher's prediction distributions, and vice versa. An overview of our knowledge ensemble teacher model architecture 200 is illustrated in FIG. 3. The model consists of two components: (1) m auxiliary branches with the same configuration (Res4X block and an individual classifier), each of which serves as an independent classification model with shared low-level stages/layers. This is because low-level features are largely shared across different network instances and sharing them allows to reduce the training cost. (2) A gating component which learns to ensemble all (m+1) branches to build a stronger teacher model. This is constructed by one fully connected (FC) layer followed by batch normalisation, ReLU activation, and softmax, using the same input features as the branches. One may construct a set of student networks and update them asynchronously. A simple weighted model representation fusion may then be performed, e.g. normalised weighted summation or average (mean pooling) or max sampling (max pooling). In contrast, the present multi-branch single teacher model has more optimised model learning due to a multi-branch simultaneous learning regularisation of all the model representations which benefits the overall teacher model generalisation, whilst avoiding asynchronous model update that may not be accessible in practice if they are distributed. In knowledge dissemination, the present system and method may convert the trained multi-branch model back to the original (single-branch) network architecture by removing the auxiliary branches, which avoids increasing model deployment computing cost.

FIG. 3 provides an overview of this knowledge distillation teacher model construction. The target network is reconfigured by adding m auxiliary branches on shared low-level model representation layers. All branches, together with shared layers, form individual models. Their ensemble may be in the form of a multi-branch network, which is then used to construct a stronger teacher model. Once all of the multiple branches are ensembled, a model training process may be initiated so that the teacher assembles knowledge of branch models, which is in turn is distilled back to all branches to enhance the model learning in a closed-loop form. After carrying out this teacher model training (together with all the branches), auxiliary branches are discarded (or kept) whilst the enhanced target model may be disseminated to its original target domain. This may depend on different application target domain requirements and restrictions.

A person Re-ID task may be used to search for the same people among multiple camera views, for example. Recently, most person Re-ID approaches [72, 65, 12, 14, 49, 56, 11, 76, 25, 9, 73, 74, 13, 57, 54] try to solve this problem under the supervised learning framework, where the training data is fully annotated. Despite the high performance of these methods, their large annotation cost present difficulties. To address the high labelling cost problem, some earlier techniques propose to learn the model with only a few labelled samples or without any label information. Representative algorithms [48, 70, 4, 79, 39, 64, 45, 66] include domain transfer schemes, group association approaches, and some label estimation methods.

Besides the above-mentioned approaches, some earlier techniques aim to reduce the annotation cost in a human-in-the-loop (HITL) model learning process. When there are only a few annotated image samples, HITL model learning can be expected to improve the model performance by directly involving human interaction in the circle of model training, tuning or testing. When a human population is used to correct inaccuracies that occur in machine learning predictions, the model may be efficiently corrected and improved, thereby leading to better results. This is similar to the situation of a person Re-ID task whose pre-labelling information is hard to obtain with the gallery candidate size far beyond that of the query anchor. Wang et al. [63] formulates a Human Verification Incremental Learning (HVIL) model which aims to optimize the distance metric with flexible human feedback continuously in real-time. The flexible human feedback (true, false, false but similar) employed by this model involves more information and boosts the performance in a progressive manner. However, this technique still has increased time and resource costs.

Active Learning may be compared against Reinforcement Learning. Active Learning (AL) has been popular in the field of Natural Language Processing (NLP), data annotation and image classification tasks [59, 10, 6, 47]. Its procedure can be thought as human-in-the-loop setting, which allows an algorithm to interactively query the human annotator with instances recognized as the most informative samples among the entire unlabelled data pool. This work is usually done by using some heuristic selection methods but they have been met with limited effectiveness. Therefore, an aim is to address the shortcomings of the heuristic selection approaches by framing the active learning as a reinforcement learning (RL) problem to explicitly optimize a selection policy. In [20], rather than adopting a fixed heuristic selection strategy, Fang et al. attempts to learn a deep Q-network as an adaptive policy to select the data instances for labelling. Woodward et al [67] try to solve the one-shot classification task by formulating an active learning approach which incorporates meta-learning with deep reinforcement learning. An agent 120 learned via this approach may be enable to decide how and when to request a label.

Knowledge transfer may be attempted between varying-capacity network models [8, 28, 3, 51]. Hinton et al. [28] distilled knowledge from a large pre-trained teacher model to improve a small target net. The rationale behind this is in taking advantage of extra supervision provided by the teacher model during training the target model, beyond a conventional supervised learning objective such as the cross-entropy loss subject to the training data labels. Extra supervision may be extracted from a pre-trained powerful teacher model in form of class posterior probabilities [28], feature representations [3, 51], or inter-layer flow (the inner product of feature maps) [69]. Knowledge distillation may be exploited to distil easy-to-train large networks into harder-to-train small networks [28], to transfer knowledge within the same network [37, 21], and to transfer high-level semantics across layers [36]. Earlier distillation methods often take an offline learning strategy, requiring at least two phases of training. The more recently proposed deep mutual learning [75] overcomes this limitation by conducting an online distillation in one-phase training between two peer student models. Anil et al. [2] further extended this idea to accelerate the training of large scale distributed neural networks.

However, the existing online distillation methods lack a strong “teacher” model which limits the efficacy of knowledge discovery. As an offline counterpart, multiple nets are needed to be trained, which is therefore computationally expensive. The present system and methods overcome these limitations by providing an online distillation training algorithm characterised by simultaneously learning a teacher online and the target net, as well as performing batch-wise knowledge transfer in a one-phase training procedure.

Multi-branch Architectures may be based on neural networks and these can be exploited in computer vision tasks [60, 61, 26]. For example, ResNet [26] can be thought of as a category of a two-branch network where one branch is an identity mapping. Recently, “grouped convolution” [68, 31] has been used as a replacement of standard convolution in constructing multi-branch net architectures. These building blocks may be utilised as templates to build deeper networks to gain stronger model capacities. Despite sharing the multi-branch principle, the present method is fundamentally different from such existing methods since there is an objective is to improve the training quality of any target network, but not to use a new multi-branch building block. In other words, the present method may be described as a meta network learning algorithm, independent of the network architecture design.

Distributed Cumulative Model Optimisation On-Site

The following describes a base CNN Network. Initially, a generic deep Convolutional Neural Network (CNN) architecture may be provided as the base network with ImageNet pre-training, e.g. either Resnet-50 [26] or ResNet-110 [26]. It may be straightforward to apply any other network architectures as alternatives. To effectively learn the ID discriminative feature embedding, the present system and method may use both cross entropy loss for classification and triplet loss for similarity learning synchronously.

The softmax Cross Entropy loss function may be defined as:

$${L}_{cross} = - \frac{1}{{n}_{b}} {\sum }_{i = 1}^{{n}_{b}} log ( {p}_{i} ( y ) ) \qquad ( 1 )$$

where n_{b} denotes the batch size and pᵢ (y) is the predicted probability on the groundtruth class y of an input image.

Given triplet samples xₐ, xₚ, xₙ, xₐ is an anchor point. xₚ is hardest positive sample in the same class of xₐ, and xn is a hardest negative sample of a different class of xₐ. Finally we define the triplet loss as following:

$${L}_{tri} = {\sum }_{{x}_{a} , {x}_{p} , {x}_{n}}^{{n}_{b}} [ {D}_{{x}_{a} , {x}_{p}} - {D}_{{x}_{a} , {x}_{n}} + m ] \qquad ( 2 )$$

where m is a margin parameter for the positive and negative pairs.

Finally, the total loss for can be calculated by:

Lₜₒₜₐₗ=L_{cross}+Lₜᵣᵢ (3)

A Deep Reinforced Active Learner—An Agent

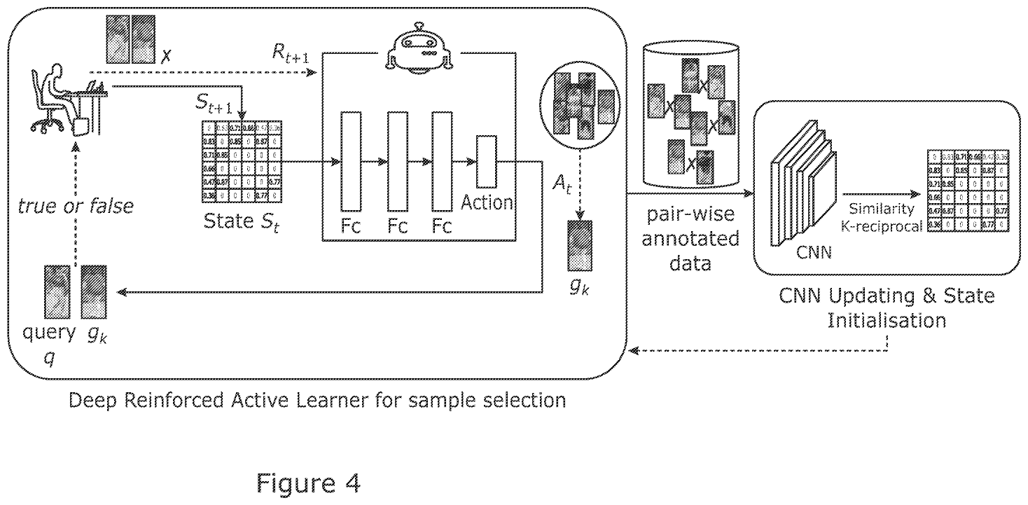

The framework of the present DRAL is presented in FIG. 4, of which “an agent” (model) is designed to dynamically select instances that are most informative to the query instance. As each query instance arrives, the system perceives its nₛ—nearest neighbours as the unlabelled gallery pool. At each discrete time step t, the environment provides an observation state Sₜ which reveals the instances' relationship, and receives a response from the agent 120 by selecting an action Aₜ. For the action Aₜ=gₖ, it requests the k-th instance among the unlabelled gallery pool being annotated by the human oracle 110, who replies with binary feedback of true or false against the query. This operation repeats until a maximum annotation amount for each query is exhausted. When plentiful enough pair-wise labelled data are obtained, the CNN parameters may be updated via a triplet loss function, which in return generates a new initial state for incoming data. Through iteratively executing the sample selection and CNN network refreshing, the proposed algorithm can quickly escalate. This progress may terminate when all query instances have been browsed once. More details about the proposed active learner are described in the following. Table 1 provides the definitions of the notations.

TABLE 1
Definitions of notations.

| Notations | Description |
|---|---|
| [symbol] ₜ, Sₜ, Rₜ | action, state and reward at time t |
| Sim(i, j) | similarity between samples i, j |
| dᵢ^{j} | Mahalanobis distance of i, j |
| q, gₖ | query, the k-th gallery candidate |
| yₖ^{t} | binary feedback of gₖ at time t |
| Xₚ^{t}, Xₙ^{t} | positive/negative sample batch until time t |
| Kₘₐₓ | annotating sample number for each query |
| nₛ | action size |
| κ | parameter of reciprocal operation |
| thred | threshold parameter |

The Deep Reinforcement Active Learning (DRAL) framework is shown in FIG. 4. State measures the similarity relations among all instance. Action determines which gallery candidate will be sent for human annotator 110 for querying. Reward is computed with different human feedback. A CNN is adopted for state initialization and is updated following pairwise data annotated by a human annotator in-the-loop online when the model is deployed. This iterative process stops when it reaches the annotation budget.

The Action set defines a selection of an instance from the unlabelled gallery pool, hence its size is the same as the pool. At each time step t, when encountered with the current state Sₜ, the agent 120 decides the action to be taken based on its policy π(Aₜ|Sₜ). Therefore the Aₜ instance of the unlabelled gallery pool will be selected querying by human oracle 110. Once Sₜ=gₖ is performed, the agent 120 may be prevented from choosing it again in subsequent steps. The termination criterion of this process depends on a pre-defined Kₘₐₓ which restricts the maximal annotation amount for each query anchor.

State. Graph similarity may be employed for data selecting in active learning framework [22, 46] by digging the structural relationships among data points. Typically, a sparse graph may be adopted which only connects data point to a few of its most similar neighbours to exploit their contextual information. In an example implementation a sparse similarity graph is constructed among query and gallery samples and this is taken as the state value. With a queried anchor q and its corresponding gallery candidate set g={g₁, g₂, . . . , gₙ_{ₛ}}, the Re-ID features may be extracted via the CNN network, where nₛ is a pre-defined number of the gallery candidates. The similarity value Sim(i,j) between every two samples i, j are then calculated as:

$$Sim ( i , j ) = 1 - \frac{{d}_{i}^{j}}{{max}_{i , j ∈ q , g} {d}_{i}^{j}} \qquad ( 4 )$$

where dᵢ^{j} is the Mahalanobis distance of i, j. A k-reciprocal operation is executed to build the sparse similarity matrix. For any node nᵢϵ(q, g) of the similarity matrix Sim, its top κ-nearest neighbours are defined as N(nᵢ, κ). Then the κ-reciprocal neighbours R(nᵢ, κ) of nᵢ is obtained through:

R(nᵢ,κ)={xⱼ|(nᵢϵN(xⱼ,κ))\hat{ }(xⱼϵN(nᵢ,κ))} (5)

Compared with the previous description, the κ-reciprocal nearest neighbours are more related to the node nᵢ, of which the similarity value remains or otherwise will be assigned as zero. This sparse similarity matrix is then taken as the initial state and imported into the policy network for action selection. Once the action is employed, the state value may be adjusted accordingly to better reveal the sample relations.

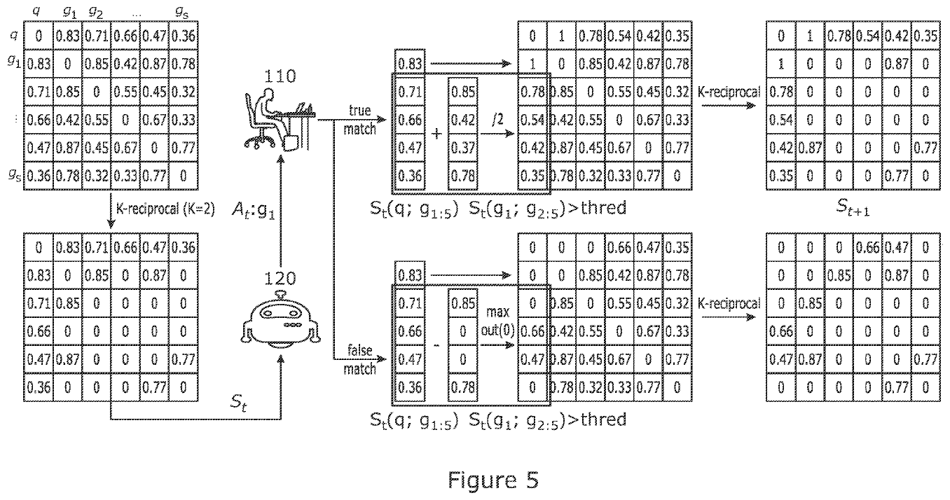

To better understand the update of state value, an example is provided in FIG. 5, which illustrates an example of state updating with different human feedback. This aims to narrow the similarities among instances sharing high correlations with negative samples, and enlarge the similarities among instances which are highly similar to the positive samples. The values with shaded background are the state imported into the agent 120.

For a state Sₜ at time t, the optimal action Aₜ=gₖ may be selected via the policy network, which indicates that the gallery candidate gₖ will be selected for querying by the human annotator 110. A binary feedback is the provided as yₖ^{t}={1, −1}, which indicates gₖ to be the positive pair or negative of the query instance. Therefore the similarity Sim(q, gₖ) between q and gₖ will be set as:

$$Sim ( q , {g}_{k} ) = \{ \begin{matrix}1 , & {y}_{k}^{t} = 1 \\ 0 , & {y}_{k}^{t} = - 1\end{matrix} \qquad ( 6 )$$

The similarities of the remaining gallery samples gᵢ, i≠k and query sample may also be re-computed, which aims to zoom in the distance among positives and push out the distance among negatives. Therefore, with positive feedback, the similarity Sim(q, gᵢ) is the average score between gᵢ with (q, gₖ), where:

$$Sim ( q , {g}_{i} ) = \frac{Sim ( q , {g}_{i} ) + Sim ( q , {g}_{k} )}{2} \qquad ( 7 )$$

Otherwise, the similarity Sim(q, gᵢ) will only be updated when the similarity among gₖ and gᵢ is larger than a threshold thred, where:

Sim(q,gᵢ)=max(Sim(q,gᵢ)—Sim(gₖ,gᵢ),0) (8)

he k-reciprocal operation will also be adopt afterwards, and a renewed state Sₜ₊₁ is then obtained.

Reward. The reward function defines the agent task objective, which in the very specific task of active sample selecting for person re-id occasion, aiming to pick out more true positive match and hard-differentiate negative samples for each query at a fixed annotation budget.

Standard active learning methods adopt an uncertainty measurement, hypotheses disagreement or information density as the selection function for classification [7, 24, 81, 71]. A data uncertainty may be adopted as the objective function of the reinforcement learning policy.

For data uncertainty measurement, higher uncertainty indicates that the sample is harder to distinguish. Following the same principle [62] which extends a triplet loss formulation to model heteroscedastic uncertainty in a retrieval task, a similar hard triplet loss [27] may be performed to measure the uncertainty of data. Let Xₚ^{t}, Xₙ^{t} indicate the positive and negative sample batch obtained until time t, d_{g}_{ₖ}^{x} be a metric function measuring Mahalanobis distances between any two samples gₖ and x. Then the reward may be computed as:

$${R}_{t} = {[ m + {y}_{k}^{t} ( {max}_{{x}_{i} ∈ {X}_{p}^{t}} {d}_{{g}_{k}}^{{x}_{i}} - {min}_{{x}_{j} ∈ {X}_{n}^{t}} {d}_{{g}_{k}}^{{x}_{j}} ) ]}_{+} \qquad ( 9 )$$

where [•]₊ is the soft margin function by at least a margin m. Therefore, all of the future rewards (Rₜ₊₁, Rₜ₊₂, . . . ) discounted by a factor Tat time t can be calculated as:

$${Q}^{*} = {max}_{π} 𝔼 [ {R}_{t} + γ {R}_{t + 1} + {γ}^{2} {R}_{t + 2} ⋯ \vert π , {S}_{t} , {A}_{t} ] \qquad ( 10 )$$

Once Q* is learned, the optimal policy π* can be directly inferred by selecting the action with the maximum Q value.

CNN Network Updating. For each query anchor, several samples may be actively selected via the proposed DRAL agent 120, which are then manually annotated by the human oracle 110. These pairwise data will be added to an updated training data pool (e.g. a training data set). The CNN network may then be updated gradually using fine-tuning. The triplet loss may be used as the objective function, and when more labelled data is involved, the model becomes more robust and smarter. The renewed network is employed for Re-ID feature extraction, which in return helps the upgrade of the state initialization. This iterative training scheme may be stopped when a fixed annotation budget is reached or when each image in the training data pool has been browsed once by our DRAL agent 120.

Simultaneous Knowledge Ensemble and Distillation

An online knowledge distillation training method may be based on the idea of simultaneous knowledge ensemble and distillation (SKED). A base network architecture may be either a CNN ResNet-50 or ResNet-110. Other network architectures may be adopted. For model construction, n labelled training samples for [symbol] ={(xᵢ, yᵢ)}ᵢⁿ with each belonging to one of C classes yᵢϵ [symbol] ={1, 2, . . . , C}.

The network θ outputs a probabilistic class posterior p(c|x, θ) for a sample x over a class c as:

$$p ( c \vert x , θ ) = {f}_{sm} ( z ) = \frac{exp ( {z}^{c} )}{{\sum }_{j = 1}^{C} exp ( {z}^{j} )} , c ∈ 𝒴 \qquad ( 11 )$$

where z is the logits or unnormalised log probability outputted by the network θ. To train a multi-class classification model, the Cross-Entropy (CE) measurement may be employed between a predicted and a ground-truth label distribution as the objective loss function:

$${ℒ}_{c e} = - {\sum }_{c = 1}^{C} {δ}_{c , y} log ( p ( c \vert x , θ ) ) \qquad ( 12 )$$

where δ_{c,y} is the Dirac delta which returns 1 if c is the ground-truth label, and 0 otherwise. With the CE loss, the network may be trained to predict the correct class label in a principle of maximum likelihood. To further enhance the model generalisation, extra knowledge may be distilled from an online native ensemble teacher to each branch in training.

Multi-Branch Teacher Model Ensemble. An overview of a global knowledge ensemble model is illustrated in FIG. 3, which consists of two components: (1) m auxiliary branches with the same configuration (Res4X block and an individual classifier), each of which serves as an independent classification model with shared low-level stages/layers. This is because low-level features are largely shared across different network instances and sharing them allows to reduce the training cost. (2) A gating component which learns to ensemble all (m+1) branches to build a stronger teacher model. This may be constructed by one fully connected (FC) layer followed by batch normalisation, ReLU activation, and softmax, using the same input features as the branches.

To construct a model network, the model may be reconfigured by adding a separate CE loss [symbol] _{ce}ⁱ to each branch which simultaneously learns to predict the same ground-truth class label of a training sample. While sharing the most layers, each branch can be considered as an independent multi-class classifier in that all of them independently learn high-level semantic representations. Consequently, taking the ensemble of all branches (classifiers) can make a stronger teacher model. One common way of ensembling models is to average individual predictions. This may ignore the diversity and importance variety of the member models of an ensemble. Whilst this may be used, an improved technique is to learn to ensemble by a gating component as:

$${z}_{e} = {\sum }_{i = 0}^{m} {g}_{i} \cdot {z}_{i} \qquad ( 13 )$$

where gᵢ is the importance score of the i-th branch's logits zᵢ, and zₑ are the logits of the teacher. In particular, the original branch may be denoted as i=0 for indexing convenience. The teacher model may be trained with the CE loss [symbol] _{ce}^{e} (Eq (12)), which may be the same as the branches.

Knowledge Distillation. Given the teacher's logits of each training sample, this knowledge may be distilled back into all branches in a closed-loop form. For facilitating knowledge transfer, soft probability distributions may be computed at a temperature of T for individual branches and the teacher as:

$${\tilde{p}}_{i} ( c \vert x , {θ}^{i} ) = \frac{exp ( {z}_{i}^{c} / T )}{{\sum }_{j = 1}^{C} exp ( {z}_{i}^{j} / T )} , c ∈ 𝒴 \qquad ( 14 )$$

$${\tilde{p}}_{e} ( c \vert x , {θ}^{e} ) = \frac{exp ( {z}_{e}^{c} / T )}{{\sum }_{j = 1}^{C} exp ( {z}_{e}^{j} / T )} , c ∈ 𝒴 \qquad ( 15 )$$

where i denotes the branch index, I=0, . . . , m, θⁱ and θ^{e} the parameters of the branch and teacher models respectively. Higher values of T lead to more softened distributions.

To quantify the alignment of model representations between individual branches and the teacher ensemble in their predictions, we use the Kullback Leibler divergence from branches to the teacher, defined as

$${ℒ}_{kl} = {\sum }_{i = 0}^{m} {\sum }_{j = 1}^{C} {\tilde{p}}_{e} ( j / x , {θ}^{e} ) log \frac{{\tilde{p}}_{e} ( j / x , {θ}^{e} )}{{\tilde{p}}_{i} ( j / x , {θ}^{i} )} . \qquad ( 16 )$$

Overall Loss Function. An overall loss function is obtained for simultaneous knowledge ensemble and distillation (SKED) training as:

$$ℒ = {\sum }_{i = 0}^{m} {ℒ}_{ce}^{i} + {ℒ}_{ce}^{e} + {T}^{2} * {ℒ}_{kl} \qquad ( 17 )$$

Where [symbol] _{ce}ⁱ and [symbol] _{ce}^{e} are the conventional CE loss terms associated with the i-th branch and the teacher, respectively. The gradient magnitudes produced by the soft targets \tilde{p} are scaled by

$$\frac{1}{{T}^{2}} ,$$

so the distillation loss term is multiplied by a factor T² to ensure that the relative contributions of ground-truth and teacher probability distributions remain roughly unchanged. Note, the overall objective function of this model is not an ensemble learning since (1) these loss functions corresponding to the models with different roles, and (2) the conventional ensemble learning often takes independent training from member models.

Model Update and Deployment. Unlike a two-phase offline distillation training, the enhancement/update of a target network and the global teacher model may be performed simultaneously and collaboratively, with the knowledge distillation obtained from the teacher to the target being conducted in each mini-batch and throughout the whole training procedure. Since there is one multi-branch network rather than multiple networks, there is only a need to carry out the same stochastic gradient descent through (m+1) branches, and training the whole network until converging, as the standard single-model incremental batch-wise training. There is no additional complexity for asynchronously updating among different networks which may be required in deep mutual learning [75]. Once the model is trained, all the auxiliary branches may be removed in order to obtain the original network architecture for deployment. Hence, the present method does not generally increase the test-time cost. Moreover, if the target application domain has no limitation on resources and access, then an ensemble model with all branches can be more easily deployed.

Experiment 1—Distributed Optimisation On-Site

Datasets. The following describes the results of various experiments used to evaluate the present system and method. For experimental evaluations, results on both large-scale and small-scale person re-identification benchmarks are reported for robust analysis: The Market-1501 [77] is a widely adopted large-scale re-id dataset that contains 1,501 identities obtained by Deformable Part Model pedestrian detector. It includes 32,668 images obtain from 6 non-overlapping camera views on a campus. CUHK01 [40] is a remarkable small-scale re-id dataset, which consists of 971 identities from two camera views, where each identity has two images per camera view and thus includes 3884 images which are manually cropped. Duke [50] is one of the most popular large scale re-id dataset which consists 36411 pedestrian images captured from 8 different camera views. Among them, 16522 images (702 identities) are adopted for training, 2228 (702 identities) images are taken as query to be retrieved from the remaining 17661 images.

Evaluation Protocols. The detailed information about training/testing split of these three datasets are demonstrated in Table 2.

TABLE 2
Details of the datasets. The number of images and identities
are shown either side of the “/”, respectively. T: Train set, Q: Query set, and G: Gallery set.

| Datasets | | CUHK01 | Market1501 | Duke |
|---|---|---|---|---|
| Splits | T | 1940/485 | 12936/751 | 16522/702 |
| | Q | 972/486 | 3368/750 | 2228/702 |
| | G | 972/486 | 15913/751 | 17661/1110 |

For Market-1501 [77], [78] is followed with 750 training/751 test split on single-query evaluation settings. For Duke [50] 702 training/702 test split are evaluated. A 485 training/486 test split is used for the CUHK01 dataset [40]. Two evaluation metrics are adopted in this approach to evaluate the Re-ID performance. The first one is the Cumulated Matching Characteristics (CMC), and the second is the mean average precision (mAP) which considering person Re-ID task as an object retrieval problem.

Implementation Details. the proposed DRAL method is implemented using the Pytorch framework. A resnet-50 multi-class identity discrimination network is re-trained with a combination of triplet loss and cross entropy loss by 60 epochs (pre-train on Duke for Market1501 and CUHK01, pre-train on Market1501 for Duke), at a learning rate of 5E-4 by using the Adam optimizer. The final FC layer output feature vector (2,048-D) is extracted as the re-id feature vector in the present model by resizing all of the training images as 256×128. The policy network in this method consists of three FC layers setting as 256. The DRAL model is randomly initialized and then optimized with the learning rate at 2E-2, and (Kₘₐₓ, nₛ, K) are set as (10, 30, 15) by default. The κ-reciprocal number for sparse similarity construction is set as 15 in this work. The balanced parameter thred and m are set as 0.4 and 0.2, respectively. With every 25% of the training data swarmed into the labelled pairwise data pool, the CNN network is fine-tuned with learning rate at 5E-6.

Performance Evaluation. Human-in-the-loop person re-identification does not require the pre-labelling data, but receives user feedback for the input query little by little. It is feasible to label many of the gallery instances, but to cut down the human annotation cost, an active learning technique is performed for sample selecting. Therefore, the proposed DRAL method (the present method and system) is compared with some active learning based approach and unsupervised/transfer based methods. The results are shown in table 3 in which we use the terminology ‘uns/trans’, ‘active’ to indicate the training style under investigation. Moreover, baseline results are computed by directly employing the pre-trained CNN model, and the upper bound result indicates that the model is fine-tuned on the dataset with fully supervised training data.

For unsupervised/transfer learning setting, thirteen state-of-the-arts approaches are selected for comparison including UMDL [48], PUL [19], SPGAN [16], Tfusion [44], TL-AIDL [64], ARN [42], TAUDL [39], CAMEL [70], SSDAL [58].

In tables 3, 4 and 6, the rank-1, 5, 10 matching accuracy is illustrated and mAP(%) performance on the Market1501 [77], Duke [50] and CUHK01 [40] dataset, of which the results of the present approach are in bold. The present method achieves 84.32% and 66.07% at rank-1 and mAP, which outperforms the second best unsupervised/transfer approaches by 14.02% and 24.87% on Market1501 [77] benchmark. For Duke [50] and CUHK01 [40] datasets, DRAL also achieves fairly good performance with rank-1 matching rate at 75.31% and 76.95%.

TABLE 3
Rank-1, 5, 10 accuracy and mAP (%) with some unsupervised and adaption
approaches on the Market1501 dataset.

| | | Market1501 | | | |
|---|---|---|---|---|---|
| style | Methods | mAP | R-1 | R-5 | R-10 |
| uns/ | UMDL [48] | 22.4 | 34.5 | 52.6 | 59.6 |
| trans | PUL [19] | 20.7 | 45.5 | 60.7 | 66.7 |
| | SPGAN [16] | 26.9 | 58.1 | 76.0 | 82.7 |
| | TFusion [44] | — | 60.75 | 74.4 | 79.25 |
| | TL-AIDL [64] | 26.5 | 58.2 | 74.8 | 81.1 |
| | ARN [42] | 39.4 | 70.3 | 80.4 | 86.3 |
| | TAUDL [39] | 41.2 | 63.7 | 77.7 | 82.8 |
| | CAMEL [70] | 26.3 | 54.5 | — | — |
| | SSDAL [58] | 19.6 | 36.4 | — | — |
| active | Random | 35.15 | 58.02 | 79.07 | 85.78 |
| | QIU [15] | 44.99 | 67.84 | 85.69 | 91.12 |
| | QBC [1] | 46.32 | 68.35 | 86.07 | 91.15 |
| | GD [17] | 49.3 | 71.44 | 87.05 | 91.42 |
| | HVIL [63] | — | 78.0 | — | — |
| Ours | Baseline | 20.04 | 42.79 | 62.32 | 70.04 |
| | UpperBound | 71.62 | 87.26 | 94.77 | 96.76 |
| | DRAL | 66.07 | 84.32 | 93.97 | 96.05 |

TABLE 4
Rank-1, 5, 10 accuracy and mAP (%) with some unsupervised
and adaption approaches on the Duke dataset.

| | | Market1501 | | | |
|---|---|---|---|---|---|
| style | Methods | mAP | R-1 | R-5 | R-10 |
| uns/ | UMDL [48] | 7.3 | 17.1 | 28.8 | 34.9 |
| trans | PUL [19] | 16.4 | 30.0 | 43.4 | 48.5 |
| | SPGAN [16] | 26.2 | 46.4 | 62.3 | 68.0 |
| | TL-AIDL [64] | 23.0 | 44.3 | — | — |
| | ARN [42] | 33.4 | 60.2 | 73.9 | 79.5 |
| | TAUDL [39] | 43.5 | 61.7 | — | — |
| | CAMEL [70] | — | 57.3 | — | — |
| active | Random | 25.68 | 44.7 | 63.64 | 70.65 |
| | QIU [15] | 36.78 | 56.78 | 74.15 | 79.31 |
| | QBC [1] | 40.77 | 61.13 | 77.42 | 82.36 |
| | GD [17] | 33.58 | 53.5 | 69.97 | 75.81 |
| Ours | Baseline | 14.87 | 28.32 | 43.27 | 50.94 |
| | UpperBound | 61.90 | 78.14 | 88.20 | 91.02 |
| | DRAL | 57.06 | 75.31 | 86.13 | 89.41 |

TABLE 5
Rank-1, 5, 10 accuracy and mAP (%) with some unsupervised
and adaption approaches on the CUHK01 dataset.

| | | Market1501 | | | |
|---|---|---|---|---|---|
| style | Methods | mAP | R-1 | R-5 | R-10 |
| uns/ | TSR [55] | — | 22.4 | 35.9 | 47.9 |
| trans | UCDTL [48] | — | 32.1 | — | — |
| | CAMEL [70] | 61.9 | 57.3 | — | — |
| | TRSTP [45] | — | 60.75 | 74.44 | 79.25 |
| active | Random | 52.46 | 51.03 | 71.09 | 81.28 |
| | QIU [15] | 56.95 | 54.84 | 76.85 | 85.29 |
| | QBC [1] | 58.88 | 57.1 | 80.04 | 86.83 |
| | GD [17] | 54.79 | 52.37 | 75.21 | 83.44 |
| Ours | Baseline | 45.55 | 43.21 | 65.74 | 73.46 |
| | UpperBound | 79.26 | 79.01 | 92.39 | 95.47 |
| | DRAL | 77.62 | 76.95 | 91.67 | 94.55 |

TABLE 6
Rank-1 accuracy and mAP (%) result by directly employing (Baseline), fully
supervised learning(UpperBound), and DRAL with varied Kₘₐₓ on the three reported dataset,
where n indicates the training instance number for each benchmark. The annotation cost is
calculated through the times of labelling behaviour for every two samples.

| | Duke | | | | Market1501 | | | | CUHK01 | | | | |
|---|---|---|---|---|---|---|---|---|---|---|---|---|---|
| Methods | mAP | R-1 | R-5 | R-10 | mAP | R-1 | R-5 | R-10 | mAP | R-1 | R-5 | R-10 | cost |
| Baseline | 14.87 | 28.32 | 43.27 | 50.94 | 20.04 | 42.79 | 62.32 | 70.04 | 45.55 | 43.21 | 65.74 | 73.46 | 0 |
| DRAL | 40.76 | 60.91 | 74.64 | 79.67 | 51.18 | 74.85 | 89.31 | 92.84 | 57.91 | 57.72 | 77.16 | 85.49 | n * 3 |
| | 52.41 | 71.05 | 83.21 | 87.79 | 60.22 | 79.93 | 91.98 | 94.89 | 67.47 | 67.48 | 84.77 | 90.95 | n * 5 |
| | 57.06 | 75.31 | 86.13 | 89.41 | 66.07 | 84.32 | 93.97 | 96.05 | 77.62 | 77.62 | 91.67 | 94.55 | n * 10 |
| UpperBound | 61.90 | 78.14 | 88.20 | 91.02 | 71.62 | 87.26 | 94.77 | 96.76 | 79.26 | 79.01 | 92.39 | 95.47 | n² |

These results demonstrate clearly the effectiveness of the present active sample selection strategy implemented by the DRAL method, and shows that without annotating exhaustively without selection large quantities of training data, an improved re-identification model can be built effectively by DRAL.

Comparisons with Active Learning. Besides the approaches as mentioned above, some active learning based approaches are compared which involve human-machine interaction during training. Four active learning strategies are chosen as comparisons of which the model is trained through the same framework as the present method, of which an iterative procedure of these active sample selection strategy and CNN parameter updating is executed until the annotation budget is achieved. Here 20% of the entire training samples are selected via the reported active learning approaches, which indicates 388, 2588, 3304 are set as the annotation budget for termination on the CUHK01 [40], Market1501 [77], and Duke [50] dataset, respectively. Beside these active learning methods, we also compare the performance with another active learning approach HVIL [63], which runs experiments under a human-in-the-loop setting. The details of these approaches are described as follows: (1) Random, as a baseline active learning approach, we randomly pick some samples for querying; (2) Query Instance Uncertainty [15] (QIU), QIU strategy selects the samples with the highest uncertainty for querying; (3) Query By Committee [1] (QBC), QBC is a very effective active learning approach which learns an ensemble of hypotheses and queries the instances that cause maximum disagreement among the committee; (4) Graph Density [17] (GD), active learning by GD is an algorithm which constructs graph structure to identify highly connected nodes and determine the most representative data for querying. (5) Human Verification Incremental Learning [17] (HVIL), HVIL is trained with the human-in-the-loop setting which receives soft user feedback (true, false, false but similar) during model training, requiring the annotator to label the top-50 candidates of each query instance.

Table 3, 4 and 6 compare the rank-1, 5, 10 and mAP rate from the active learning models against DRAL, where the baseline model result is from directly employing the pre-trained CNN model. We can observe from these results that (1) all the active learning methods perform better than the random picking strategy, which validates that active sample selection does benefit person Re-ID performance. 2) DRAL outperforms the other active learning methods, with rank-1 matching rate exceeds the second best models QBC, HVIL and GC by 19.85%, 6.32% and 14.18% on the CUHK01 [40], Market1501 [77] and Duke [40] datasets, with a much lower annotation cost. This suggests that DRAL (the present method) is more effective than other active learning methods for person Re-ID by introducing the policy as a sample selection strategy.

Comparisons on Different Sizes of Labelled Data. We further compare the performance of the proposed DRAL approach with a varying amount of labelled data (indicated by Kₘₐₓ) with fully supervised learning (UpperBound) on the three reported datasets. The rank-1, 5, 10 accuracies, mAP (%) and annotation costs are compared, where the cost is calculated through the times for labelling every two samples. Therefore with the training sample number n, the cost for the fully supervised setting will be n². With the enlargement of training data size, the cost for annotating all of the data increases exponentially. Among the results, the baseline is obtained by directly employing the pre-trained CNN for testing. For the fully supervised setting, with all the training data annotated, this enables a fine-tuning of the CNN parameters with both the triplet loss and the cross-entropy loss seeking better performance. For the present DRAL method, we present the performance with Kₘₐₓ setting as 3, 5 and 10 in Table 6. As can be observed, 1) with more data to be annotated, the model becomes stronger at the cost of increasing annotation. With the annotation number for each query increasing from 3 to 10, the rank-1 matching rate improves 14.4%, 9.47% and 19.23% on the Duke [50], Market1501 [77] and CUHK01 [40] benchmarks. 2) Compared to the fully supervised setting, the proposed active learning approach shows only around 3% rank-1 accuracy falling on each dataset. However, the annotation cost of DRAL is far below the supervised one.

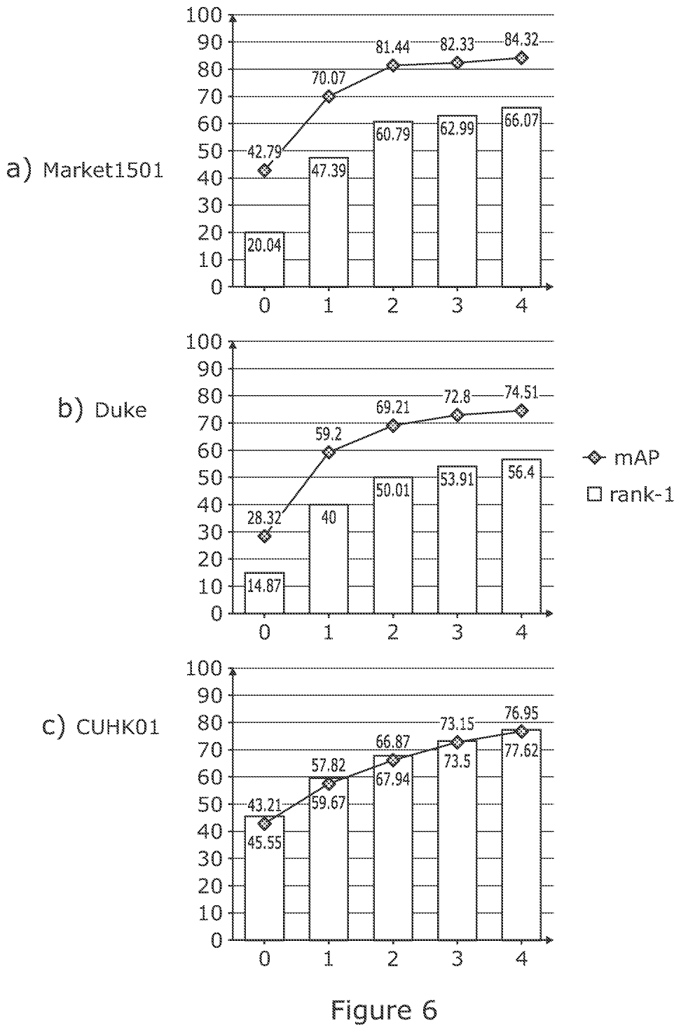

Effects from Cumulative Model Optimisation. These results demonstrate that through iteratively increasing the size of labelled data, the model performance may be enhanced gradually. For each input query, we only associate the label to the gallery candidates derived from the DRAL, and adopted these pairwise labelled data for CNN parameter updating. We set the iteration as a fixed number 4 in these experiments on all datasets. With 25% of the overall training data used for active learning, the CNN model is fine-tuned and achieves improved performance. FIG. 6 shows the rank-1 accuracy and mAP improvement with respect to the iterations on the three datasets. From these results, we can observe that the performance of the proposed DRAL active learner improves quickly, with rank-1 accuracy increases around 20%-40% over the first two iterations on all three benchmarks, and the improvement in model performance starts to flatten out after five iterations. This suggests that for person Re-ID, fully supervising may not be essential. Once the informative samples/information have been obtained, a sufficiently good Re-ID model can be derived at the cost of a much smaller annotation workload by exploring a sample selection strategy online.

Experiment 2—Knowledge Ensemble & Distillation

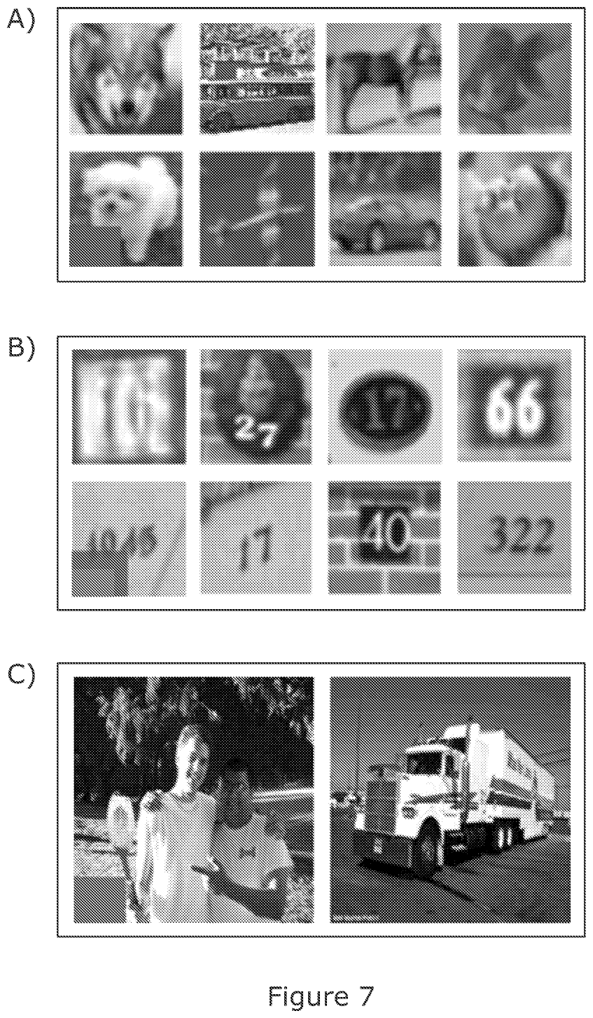

Datasets. We used four multi-class categorisation benchmark datasets in our evaluations (FIG. 7). (1) CIFAR10 [35]: A natural images dataset that contains 50,000/10,000 training/test samples drawn from 10 object classes (in total 60,000 images). Each class has 6,000 images sized at 32×32 pixels. Each of the 10 classes has 6,000 images. We follow the benchmarking setting 50,000/10,000 training/test samples. CIFAR100 [35]: A similar dataset as CIFAR10 that also contains 50,000/10,000 training/test images but covering 100 fine-grained classes. Each class has 600 images. SVHN: The Street View House Numbers (SVHN) dataset consists of 73,257/26,032 standard training/text images and an extra set of 531,131 training images. We follow common practice [32, 38]. We used all the training data without using data augmentation as [32, 38]. ImageNet: The 1,000-class dataset from ILSVRC 2012 [52] provides 1.2 million images for training, and 50,000 for validation.

FIG. 7 shows example images from (a) CIFAR, (b) SVHN, and (c) ImageNet.

Performance Metrics. We adopted the common top-n (n=1, 5) classification error rate. To measure the computational cost of model training and test, we used the criterion of floating point operations (FLOPs). For any network trained by our model, we reported the average performance of all branch outputs with standard deviation.

Experiment Setup. We implemented all networks and model training procedures in Pytorch. using NVIDIA Tesla P100 GPU. For all datasets, we adopted the same experimental settings as [34, 68] for making fair comparisons. We used the SGD with Nesterov momentum and set the momentum to 0.9. We deployed a standard learning rate schedule that drops the rate from 0.1 to 0.01 at 50% training halfway (50%) through training, and to 0.001 at 75%. For the training budget, we set 300/40/90 epochs for CIFAR/SVHN/ImageNet, respectively. We adopted a 3-branch model (m=2) design unless stated otherwise. We separated the last block of each backbone net from the parameter sharing (except on ImageNet we separated the last 2 blocks to give more learning capacity to branches) without extra structural optimisation (see ResNet-110 for example in FIG. 3). Following [28], we set T=3 in all the experiments. Cross-validation of this parameter T may give better performance but at the cost of extra model tuning.

TABLE 7
Evaluation of our method on CIFAR and SVHN. Metric: Error rate (%).

| Method | CIFAE10 | CIFAR100 | SVHN | Params |
|---|---|---|---|---|
| ResNet-32 [26] | 6.93 | 31.18 | 2.11 | 0.5M |
| ResNet-32 + SKED | 5.99 ± 0.05 | 26.61 ± 0.06 | 1.83 ± 0.05 | 0.5M |
| ResNet-110 [28] | 5.56 | 25.33 | 2.00 | 1.7M |
| ResNet-110 + SKED | 5.17 ± 0.07 | 21.62 ± 0.26 | 1.76 ± 0.07 | 1.7M |
| ResNeXt-29(8 × 64d) [68] | 3.69 | 17.77 | 1.83 | 34.4M |
| ResNeXt-29(8 × 64d) + SKED | 3.45 ± 0.04 | 16.07 ± 0.08 | 1.70 ± 0.03 | 34.4M |
| DenseNet-BC(L = 190, k −= 40) [33] | 3.32 | 17.53 | 1.73 | 25.6M |
| DenseNet-BC(L = 190, k = 40) + SKED | 3.13 ± 0.07 | 16.35 ± 0.05 | 1.63 ± 0.05 | 25.6M |

Performance Evaluation. Results on CIFAR and SVHN. Table 7 compares top-1 error rate performances of four varying-capacity state-of-the-art network models trained by the conventional and our SKED learning algorithms. We have these observations: (1) All different networks benefit from the SKED training algorithm, particularly with small models achieving larger performance gains. This suggests a generic superiority of our method for online knowledge distillation from the online teacher to the target student model. (2) All individual branches have similar performances, indicating that they have made sufficient agreement and exchanged respective knowledge to each other well through the proposed SKED teacher model during training.

TABLE 8
Evaluation of our method on ImageNet. Metric: Error rate (%).

| Method | Top-1 | Top-5 |
|---|---|---|
| ResNet-18 [28] | 30.48 | 10.98 |
| ResNet-18 + SKED | 29.45 ± 0.23 | 10.41 ± 0.12 |
| ResNeXt-50 [68] | 22.62 | 6.29 |
| ResNeXt-50 + SKED | 21.85 ± 0.07 | 5.90 ± 0.05 |
| SeNet-ResNet-18 [29] | 29.85 | 10.72 |
| SeNet-ResNet-18 + SKED | 29.02 ± 0.17 | 10.13 ± 0.12 |

Results on ImageNet. Table 8 shows the comparative performances on the 1000-classes ImageNet. It is shown that the proposed SKED learning algorithm again yields more effective training and more generalisable models in comparison to the vanilla SGD. This indicates that our method is generically applicable in large scale image classification settings.

TABLE 9
Comparison with knowledge distillation methods on CIFAR100.

| Target | | | | | | |
|---|---|---|---|---|---|---|
| Network | ResNet-32 | | | ResNet-110 | | |
| Metric | Error (%) | TrCost | TeCost | Error(%) | TrCost | TeCost |
| KD [28] | 28.83 | 6.43 | 1.38 | N/A | N/A | N/A |
| DML [75] | 29.03 ± | 2.76 | 1.38 | 24.10 ± | 10.10 | 5.05 |
| | 0.22* | | | 0.72 | | |
| SKED | 26.61 ± | 2.28 | 1.38 | 21.62 ± | 8.29 | 5.05 |
| | 0.06 | | | 0.26 | | |

*Reported results. TrCost/TeCost: Training/test cost, in unit of 108 FLOPs. Bold shows: Best and second best results.

TABLE 10
Comparison with ensembling methods on CIFAR100.

| Network | ResNet-32 | | | ResNet-110 | | |
|---|---|---|---|---|---|---|
| Metric | Error (%) | TrCost | TeCost | Error(%) | TrCost | TeCost |
| Snopshot Ensemble [30] | 27.12 | 1.38 | 6.90 | 23.09* | 5.05 | 25.25 |
| 2-Net Ensemble | 26.75 | 2.76 | 2.76 | 22.47 | 10.10 | 10.10 |
| 3-Net Ensemble | 25.14 | 4.14 | 4.14 | 21.25 | 15.15 | 15.15 |
| SKED-E | 24.63 | 2.28 | 2.28 | 21.03 | 8.29 | 8.29 |
| SKED | 26.61 | 2.28 | 1.38 | 21.62 | 8.29 | 5.05 |

*Reported results. TrCost/TeCost: Training/test cost, in unit of 108 FLOPs. Bold: Best and second best results.

Comparisons with Distillation Methods. We compared our SKED method with two representative alternative distillation methods: Knowledge Distillation (KD) [28] and Deep Mutual Learning (DML) [75]. The teacher model provides a constant uniform target distribution. For the offline competitor KD, we used a large network ResNet-110 as the teacher and a small network ResNet-32 as the student. For the online methods DML and SKED, we evaluated their performances using either ResNet-32 or ResNet-110 as the target student model. We observe from Table 9 that: (1) SKED outperforms both KD (offline) and DML (online) distillation methods in error rate, validating the performance advantages of our method over alternative algorithms when applied to different CNN models. (2) SKED takes the least model training cost and the same test cost as others, therefore giving the most cost-effective solution.

Comparisons with Ensembling Methods. Table 10 compares the performance of our multi-branch (3 branches) based model SKED-E and standard ensembling methods. It is shown that SKED-E yields not only the best test error but also enables most efficient deployment with the lowest test cost. These advantages are achieved at the second lowest training cost. Whilst Snapshot Ensemble takes the least training cost, its generalisation capability is unsatisfied with a drawback of much higher deployment cost.

It is worth noting that SKED (without branch ensemble) already outperforms comprehensively a 2-Net Ensemble in terms of error rate, training and test cost. Comparing a 3-Net Ensemble, SKED approaches the generalisation capability whilst having larger model training and test efficiency advantages.

The present methods and systems for distributed AI deep learning for model optimisation on-site and simultaneous knowledge ensemble and distillation. The present method and mechanisms avoid globally cantered human labelling on large sized training data by performing distributed target application domain specific model optimisation, and demonstrates the present method on the task of person re-identification.

First, we introduced a deep reinforcement active learning approach to human-in-the-loop selective sample feedback confirmation for incremental distributed model optimisation at each user site. Given the lack of a large quantity of pre-labelled training data, the present system and method improves the effectiveness of localised and distributed Re-ID model optimisation by a small number of selective samples and performs deep learning at-the-edge (distributed AI learning on-site). A key task for model design becomes how to select fewer and more informative data samples for model optimisation by user using an existing weak model at-the-edge (user usage per user site). A Deep Reinforcement Active Learning (DRAL) method provides a flexible reinforcement learning policy to select informative samples (ranked list) for a given input query. Those samples are then fed into a human annotator 110 so that the model can receive binary feedback (true or false) as reinforcement learning reward for DRAL model updating. Both this concept and the detailed processes for deep learning at-the-edge by distributed small data with human-in-the-loop reinforcement data mining delivers a performance advantage over current methods, including the previous non-deep learning human-in-the-loop model. An iterative model learning mechanism is implemented for simultaneously looped model optimisation update from both Deep Reinforcement Active Learning and Convolutional Neural Network training to achieve deep learning at-the-edge data mining for distributed Re-ID optimisation at each user site. Extensive performance evaluations were conducted on both large-scale and small-scale Re-ID benchmarks to demonstrate these improvements. The present system and method (DRAL) shows clear Re-ID performance advantages against current systems, including supervised learning, unsupervised/transfer learning, and human-in-the-loop relevance feedback learning based Re-ID methods.

Second, we further developed a multi-branch strong teacher ensemble model for simultaneous knowledge ensemble (from multiple model representations) and distillation (to target models). This approach can learn discriminatively both small and large deep network models with less computational cost, beyond the conventional offline methods for learning small models alone. The present method is also superior over existing online learning methods due to a very strong teacher ensemble model from multi-branch/multi-model simultaneously. Extensive performance evaluations on four image classification benchmarks show that a wide range of deep neural networks can at least benefit from the present multi-branch model ensemble and knowledge distillation mechanism. Significantly, smaller target models obtain performance gains, making the present method especially good for disseminating shared knowledge to distribute resource-limited and/or training data constrained target application domains.

### REFERENCES

[1] N. Abe and H. Mamitsuka. Query learning strategies using boosting and bagging. In ICML, pages 1-9, 1998.
[2] R. Anil, G. Pereyra, A. Passos, R. Ormandi, G. E. Dahl, and G. E. Hinton. Large scale distributed neural network training through online distillation. In International Conference on Learning Representations, 2018.
[3] J. Ba and R. Caruana. Do deep nets really need to be deep? In Advances in Neural Information Processing Systems, 2014.
[4] S. Bak, P. Carr, and J.-F. Lalonde. Domain adaptation through synthesis for unsupervised person re-identification. In ECCV, 2018.
[5] B. Barz, C. K'ading, and J. Denzler. Information-theoretic active learning for content-based image retrieval. In PR, pages 650-666, 2018.
[6] W. H. Beluch, T. Genewein, A. Nrnberger, and J. M. Khler. The power of ensembles for active learning in image classification. In CVPR, 2018.
[7] W. H. Beluch, T. Genewein, A. Nrnberger, and J. M. K'ohler. The power of ensembles for active learning in image classification. In CVPR, pages 9368-9377, 2018.
[8] C. Bucilua, R. Caruana, and A. Niculescu-Mizil. Model compression. In Proceedings of the 12th ACM SIGKDD, 2006.
[9] X. Chang, T. M. Hospedales, and T. Xiang. Multi-level factorisation net for person re-identification. In CVPR, 2018.
[10] M. Chatterjee and A. Leuski. An active learning based approach for effective video annotation and retrieval. In NIPS, 2015.
[11]W. Chen, X. Chen, J. Zhang, and K. Huang. Beyond triplet loss: A deep quadruplet network for person re-identification. In CVPR, 2017.
[12] Y. Chen, Z. Wang, Y. Peng, Z. Zhang, G. Yu, and J. Sun. Cascaded pyramid network for multi-person pose estimation. In CVPR, 2018.
[13] D. Cheng, Y. Gong, S. Zhou, J. Wang, and N. Zheng. Person re-identification by multi-channel parts-based cnn with improved triplet loss function. In CVPR, 2016.
[14] D. Chung, K. Tahboub, and E. J. Delp. A two stream siamese convolutional neural network for person re-identification. In ICCV, 2017.
[15] L. D. D and G. W. A. Training text classifiers by uncertainty sampling. In SIGIR, pages 3-12, 1994.
[16]W. Deng, L. Zheng, G. Kang, Y. Yang, Q. Ye, and J. Jiao. Image-image domain adaptation with preserved self-similarity and domain-dissimilarity for person reidentification. In CVPR, 2018.
[17] S. Ebert, M. Fritz, and B. Schiele. RALF: A reinforced active learning formulation for object class recognition. In CVPR, pages 3626-3633, 2012.
[18] H. Fan, L. Zheng, C. Yan, and Y. Yang. Unsupervised person re-identification: Clustering and fine-tuning. ACM, 2018.
[19] H. Fan, L. Zheng, C. Yan, and Y. Yang. Unsupervised person re-identification: Clustering and fine-tuning. TOMCCAP, pages 83:1-83:18, 2018.
[20] M. Fang, Y. Li, and T. Cohn. Learning how to active learn: A deep reinforcement learning approach. In EMNLP, pages 595-605, 2017.
[21] T. Furlanello, Z. C. Lipton, M. Tschannen, L. Itti, and A. Anandkumar. Born again neural networks. arXiv e-print, 2018.
[22] E. E. Gad, A. Gadde, A. S. Avestimehr, and A. Ortega. Active learning on weighted graphs using adaptive and non-adaptive approaches. In ICASSP, pages 6175-6179, 2016.
[23] P. H. Gosselin and M. Cord. Active learning methods for interactive image retrieval. TIP, pages 1200-1211, 2008.
[24] H. Guo and W. Wang. An active learning-based SVM multi-class classification model. PR, 48(5):1577-1597, 2015.

[25] Y. Guo and N.-M. Cheung. Efficient and deep person re-identification using multi-level similarity. In CVPR, 2018.
[26] K. He, X. Zhang, S. Ren, and J. Sun. Deep residual learning for image recognition. In CVPR, 2016.
[27] A. Hermans, L. Beyer, and B. Leibe. In defense of the triplet loss for person re-identification. CoRR, abs/1703.07737, 2017.
[28] G. Hinton, O. Vinyals, and J. Dean. Distilling the knowledge in a neural network. arXiv e-print, 2015.
[29] S. L. S. G. Hu, Jie. Squeeze-and-excitation networks. arXiv e-print, 2017.
[30] G. Huang, Y. Li, G. Pleiss, Z. Liu, J. E. Hoperoft, and K. Q. Weinberger. Snapshot ensembles: Train 1, get m for free. International Conference on Learning Representations, 2017.
[31] G. Huang, S. Liu, L. van der Maaten, and K. Q. Weinberger. Condensenet: An efficient densenet using learned group convolutions. arXiv e-print, 2017.
[32] G. Huang, Z. Liu, K. Q. Weinberger, and L. van der Maaten. Densely connected convolutional networks. arXiv e-print, 2016.
[33] G. Huang, Z. Liu, K. Q. Weinberger, and L. van der Maaten. Densely connected convolutional networks. In IEEE Conference on Computer Vision and Pattern Recognition, 2017.
[34] G. Huang, Y. Sun, Z. Liu, D. Sedra, and K. Q. Weinberger. Deep networks with stochastic depth. In European Conference on Computer Vision, 2016.
[35] A. Krizhevsky and G. Hinton. Learning multiple layers of features from tiny images. 2009.
[36] X. Lan, X. Zhu, and S. Gong. Person search by multi-scale matching. In European Conference on Computer Vision, 2018.
[37] X. Lan, X. Zhu, and S. Gong. Self-referenced deep learning. In Asian Conference on Computer Vision, 2018.
[38] C.-Y. Lee, S. Xie, P. Gallagher, Z. Zhang, and Z. Tu. Deeply-supervised nets. In Artificial Intelligence and Statistics, pages 562-570, 2015.
[39] M. Li, X. Zhu, and S. Gong. Unsupervised person re-identification by deep learning tracklet association. In ECCV, 2018.
[40] W. Li, R. Zhao, and X. Wang. Human reidentification with transferred metric learning. In ACCV, 2012.
[41] W. Li, X. Zhu, and S. Gong. Harmonious attention network for person reidentification. In CVPR, 2018.

[42] Y. Li, F. Yang, Y. Liu, Y. Yeh, X. Du, and Y. F. Wang. Adaptation and reidentification network: An unsupervised deep transfer learning approach to person re-identification. In CVPR, pages 172-178, 2018.
[43] X. Liu, M. Song, D. Tao, X. Zhou, C. Chen, and J. Bu. Semi-supervised coupled dictionary learning for person re-identification. In CVPR, 2014.

[44] J. Lv, W. Chen, Q. Li, and C. Yang. Unsupervised cross-dataset person reidentification by transfer learning of spatial-temporal patterns. In CVPR, 2018.
[45] J. Lv, W. Chen, Q. Li, and C. Yang. Unsupervised cross-dataset person reidentification by transfer learning of spatial-temporal patterns. In CVPR, 2018.
[46] Y. Ma, T. Huang, and J. G. Schneider. Active search and bandits on graphs using sigma-optimality. In UAI, pages 542-551, 2015.
[47] S. Paul, J. H. Bappy, and A. K. Roy-Chowdhury. Non-uniform subset selection for active learning in structured data. In CVPR, 2017.
[48] P. Peng, T. Xiang, Y. Wang, M. Pontil, S. Gong, T. Huang, and Y. Tian. Unsupervised cross-dataset transfer learning for person re-identification. In CVPR, 2016.
[49] X. Qian, Y. Fu, Y.-G. Jiang, T. Xiang, and X. Xue. Multi-scale deep learning architectures for person re-identification. In ICCV, 2017.
[50] E. Ristani, F. Solera, R. S. Zou, R. Cucchiara, and C. Tomasi. Performance measures and a data set for multi-target, multi-camera tracking. In ECCV Workshops, 2016.
[51] A. Romero, N. Ballas, S. E. Kahou, A. Chassang, C. Gatta, and Y. Bengio. Fitnets:
Hints for thin deep nets. arXiv e-print, 2014.
[52] O. Russakovsky, J. Deng, H. Su, J. Krause, S. Satheesh, S. Ma, Z. Huang, A. Karpathy, A. Khosla, M. Bernstein, et al. Imagenet large scale visual recognition challenge. International Journal of Computer Vision, 115(3):211-252, 2015.
[53] M. S. Sarfraz, A. Schumann, A. Eberle, and R. Stiefelhagen. A pose-sensitive embedding for person re-identification with expanded cross neighborhood reranking. arXiv preprint arXiv:1711.10378, 2017.
[54] Y. Shen, H. Li, S. Yi, D. Chen, and X. Wang. Person re-identification with deep similarity-guided graph neural network. In ECCV, 2018.
[55] Z. Shi, T. M. Hospedales, and T. Xiang. Transferring a semantic representation for person re-identification and search. In CVPR, 2015.
[56] C. Su, J. Li, S. Zhang, J. Xing, W. Gao, and Q. Tian. Pose-driven deep convolutional model for person re-identification. In ICCV, 2017.
[57] C. Su, F. Yang, S. Zhang, Q. Tian, L. S. Davis, and W. Gao. Multi-task learning with low rank attribute embedding for person re-identification. In ICCV, 2015.
[58] C. Su, S. Zhang, J. Xing, W. Gao, and Q. Tian. Deep attributes driven multicamera person re-identification. In ECCV, pages 475-491, 2016.
[59] H. Su, Z. Yin, T. Kanade, and S. Huh. Active sample selection and correction propagation on a gradually-augmented graph. In CVPR, 2015.
[60] C. Szegedy, W. Liu, Y. Jia, P. Sermanet, S. Reed, D. Anguelov, D. Erhan, V. Vanhoucke, A. Rabinovich, et al. Going deeper with convolutions. In IEEE Conference on Computer Vision and Pattern Recognition, 2015.
[61] C. Szegedy, V. Vanhoucke, S. loffe, J. Shlens, and Z. Wojna. Rethinking the inception architecture for computer vision. In IEEE Conference on Computer Vision and Pattern Recognition, 2016.
[62] A. Taha, Y. Chen, T. Misu, A. Shrivastava, and L. Davis. Unsupervised data uncertainty learning in visual retrieval systems. CoRR, 2019.
[63] H. Wang, S. Gong, X. Zhu, and T. Xiang. Human-in-the-loop person reidentification. In ECCV, 2016.
[64] J. Wang, X. Zhu, S. Gong, and W. Li. Transferable joint attribute-identity deep learning for unsupervised person re-identification. In CVPR, 2018.
[65] Y. Wang, Z. Chen, F. Wu, and G. Wang. Person re-identification with cascaded pairwise convolutions. In CVPR, June 2018.
[66] L. Wei, S. Zhang, W. Gao, and Q. Tian. Person transfer gan to bridge domain gap for person re-identification. In CVPR, 2018.
[67] M. Woodward and C. Finn. Active one-shot learning. CoRR, 2017. 7 [68] S. Xie, R. Girshick, P. Doll'ar, Z. Tu, and K. He. Aggregated residual transformations for deep neural networks. In IEEE Conference on Computer Vision and Pattern Recognition, 2017.
[69] J. Yim, D. Joo, J. Bae, and J. Kim. A gift from knowledge distillation: Fast optimization, network minimization and transfer learning. In IEEE Conference on Computer Vision and Pattern Recognition, 2017.
[70] H.-X. Yu, A. Wu, and W.-S. Zheng. Cross-view asymmetric metric learning for unsupervised person re-identification. In ICCV, 2017.
[71] C. Zhang and K. Chaudhuri. Beyond disagreement-based agnostic active learning. In NIPS, pages 442-450, 2014.

[72] L. Zhang, T. Xiang, and S. Gong. Learning a discriminative null space for person re-identification. In CVPR, 2016.
[73] L. Zhang, T. Xiang, and S. Gong. Learning a discriminative null space for person re-identification. In CVPR, 2016.
[74] Y. Zhang, B. Li, H. Lu, A. Irie, and X. Ruan. Sample-specific svm learning for person re-identification. In CVPR, 2016.
[75] Y. Zhang, T. Xiang, T. M. Hospedales, and H. Lu. Deep mutual learning. CVPR, 2018.
[76] H. Zhao, M. Tian, S. Sun, J. Shao, J. Yan, S. Yi, X. Wang, and X. Tang. Spindle net: Person re-identification with human body region guided feature decomposition and fusion. In CVPR, 2017.
[77] L. Zheng, L. Shen, L. Tian, S. Wang, J. Wang, and Q. Tian. Scalable person re-identification: A benchmark. In ICCV, 2015.
[78] L. Zheng, L. Shen, L. Tian, S. Wang, J. Wang, and Q. Tian. Scalable person re-identification: A benchmark. In ICCV, 2015.
[79] Z. Zheng, L. Zheng, and Y. Yang. Unlabeled samples generated by gan improve the person re-identification baseline in vitro. In ICCV, 2017.
[80] Z. Zheng, L. Zheng, and Y. Yang. Pedestrian alignment network for large-scale person re-identification. TCSVT, 2018.
[81] J. Zhu, H. Wang, B. K. Tsou, and M. Y. Ma. Active learning with sampling by uncertainty and density for data annotations. TASLP, 18(6):1323-1331, 2010.

As will be appreciated by the skilled person, details of the above embodiment may be varied without departing from the scope of the present invention, as defined by the appended claims.

For example, different data types may be used. Different reward functions may be used.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method for optimising a reinforcement learning model comprising the steps of:
receiving a labelled data set;
receiving an unlabelled data set;
generating model parameters to form an initial reinforcement learning model using the labelled data set as a training data set;
finding a plurality of matches for one or more target within the unlabelled data set using the initial reinforcement learning model;
ranking the plurality of matches;
presenting a subset of the ranked matches and corresponding one or more target, wherein the subset of ranked matches includes the highest ranked matches;
receiving a signal indicating that one or more presented match of the highest ranked matches is an incorrect match;
adding information describing the indicated incorrect one or more match and corresponding target to the labelled data set to form a new training data set; and
updating the model parameters of the initial reinforcement learning model to form an updated reinforcement learning model using the new training data set.

2. The method of claim 1, wherein the subset of ranked matches further includes the lowest ranked matches, and before updating the model parameters of the initial reinforcement model, the method further comprising the steps of:
receiving a signal indicating that one or more presented match of the lowest ranked matches is a correct match; and
adding information describing the indicated correct one or more match and corresponding target to the new training data set.

3. The method of claim 1 or claim 2, wherein the unlabelled data set is larger than the labelled data set.

4. The method according to any previous claim further comprising the steps of:
finding a plurality of new matches for one or more new target within the unlabelled data set using the updated reinforcement learning model;
ranking the plurality of new matches;
presenting a subset of the ranked new matches and corresponding one or more target, wherein the subset of ranked matches includes the highest ranked matches;
receiving a signal indicating that one or more presented match of the highest ranked new matches is an incorrect match;
adding information describing the indicated one or more incorrect new match and corresponding new target to the labelled data set to form a further new training data set; and
updating the model parameters of the initial reinforcement learning model to form an updated reinforcement learning model using the further new training data set.

5. The method of claim 4, wherein the subset of ranked new matches further includes the lowest ranked new matches, and before updating the model parameters of the updated reinforcement model, the method further comprising the steps of:
receiving a signal indicating that one or more presented new match of the lowest ranked new matches is a correct match; and
adding information describing the indicated correct one or more new match and corresponding target to the further new training data set.

6. The method of claim 4 or claim 5 further comprising iterating the finding, ranking, presenting, receiving and updating steps for one or more further targets to further update the reinforcement learning model each iteration.

7. The method according to any of claims 4 to 6, wherein the one or more new target is a different target to an earlier one or more target.

8. The method according to any previous claim, wherein the step of updating the model parameters of the reinforcement learning model further comprises:
finding a maximised reward applied to an action sequence used to update the model parameters of the initial reinforcement learning model.

9. The method of claim 8, wherein the reward, R, is defined by:
$${R}_{t} = {[ m + {y}_{k}^{t} ( {max}_{{x}_{i} ∈ {X}_{p}^{t}} {d}_{gk}^{xi} - {min}_{{x}_{j} ∈ {X}_{n}^{t}} {d}_{gk}^{xj} ) ]}_{+}$$
where Xₚ^{t}, Xₙ^{t} are positive and negative sample batches obtained until time t, d_{g}_{ₖ}^{x} is a function of a Mahalanobis distance between any two samples gₖ and x, and [•]₊ is a soft margin function by at least a margin m.

10. The method of claim 8 or claim 9 further comprising the step of maximising Q* according to:
$${Q}^{*} = {max}_{π} 𝔼 [ {R}_{t} + γ {R}_{t + 1} + {γ}^{2} {R}_{t + 2} … \vert π , {S}_{t} , {A}_{t} ]$$
for all future rewards (Rₜ₊₁, Rₜ₊₂, . . . ) discounted by a factor γ to find an optimal policy π* used to update the model parameters of the reinforcement learning model.

11. The method according to any previous claim further comprising the step of forming a new reinforcement learning model by combining model parameters of the updated reinforcement learning model with a different updated reinforcement learning model that was generated using a different unlabelled data set.

12. The method according to any previous claim, wherein the labelled data set and the unlabelled data set are image data sets, natural language data sets, or geo-location data sets.

13. The method according to any previous claim, wherein presenting the subset of the matches and corresponding one or more target and receiving the signal further comprises presenting to a user an image of the target and an image matched with the target and receiving a true response from the user when the user determines a match and a false response from the user determines that the images don't match.

14. The method according to any previous claim, wherein the initial and new reinforcement learning models are generated using a convolutional neural network architecture.

15. The method according to any previous claim, wherein ranking the plurality of matches is based on:
a softmax Cross Entropy loss function:
$${L}_{cross} = - \frac{1}{{n}_{b}} {\sum }_{i = 1}^{{n}_{b}} log ( {p}_{1} ( y ) )$$
where n_{b} is a batch size and pᵢ(y) is a predicted probability on a ground-truth class y of an input target and a triplet loss is defined by:
$${L}_{tri} = {\sum }_{{x}_{a} , {x}_{p} , {x}_{n}}^{{n}_{b}} [ {D}_{{x}_{a} , {x}_{p}} - {D}_{{x}_{a} , {x}_{n}} + m ]$$
where m is a margin parameter for positive and negative pairs for triplet samples xₐ being an anchor point, xₚ being a hardest positive sample, and xₙ being a negative sample of a different class to xₐ, where the loss is calculated from:
Lₜₒₜₐₗ=L_{cross}+Lₜᵣᵢ.

16. The method according to any previous claim further comprising the step of selecting matches to present as the subset of matches.

17. The method of claim 16, wherein the subset of matches is selected by building a sparse similarity graph based on a similarity value Sim(i,j) between two samples i, j calculated from
$$Sim ( i , j ) = 1 - \frac{{d}_{i}^{j}}{{max}_{i , j ∈ q , g} {d}_{i}^{j}}$$
where q is the target and g={g₁, g₂, . . . , gₙ_{ₛ}} is the plurality of matches for the target, nₛ is a pre-defined number of matches, and dᵢ^{j} is a Mahalanobis distance of i,j.

18. The method of claim 17 further comprising the step of executing a k-reciprocal operation to build the sparse similarity matrix having nodes nᵢϵ(q, g), where k-nearest neighbour are defined as N(nᵢ,k), and k-reciprocal neighbours R(nᵢ,k) of ni are obtained by:
R(nᵢ,κ)={xⱼ|(nᵢϵN(xⱼ,κ))\hat{ }(x^{j}ϵN(nᵢ,κ))}.

19. The method according to any previous claim further comprising the step of merging the parameters of the updated reinforcement learning model with parameters of a different updated reinforcement learning model trained using a different unlabelled training data set, to form a further cumulation of distributed reinforcement learning models.

20. A method for optimising a reinforcement learning model comprising the steps of:
receiving from a first node, first model parameters of a first reinforcement learning model, the first reinforcement learning model trained using a first labelled data set and a first unlabelled data set as training data sets;
receiving from a second node, second model parameters of a second reinforcement learning model, the second reinforcement learning model trained using a second labelled data set and a second unlabelled data set as training data sets; and
merging the first and second model parameters to define a further reinforcement learning model.

21. The method of claim 20, wherein the first labelled data set same is the second labelled data set.

22. The method of claim 20 or claim 21 further comprising the steps of:
receiving from one or more further nodes, one or more further model parameters of one or more further reinforcement learning models, the one or more further reinforcement learning models trained using one or more further labelled data sets and one or more further unlabelled data sets as training data sets; and
merging the first, second and one or more further model parameters to define a further cumulation of distributed reinforcement learning models.

23. The method according to any of claims 20 to 22 further comprising the step of sending the merged first and second model parameters to the first and second nodes.

24. The method of claim 23 further comprising the step of the first and second and second nodes using the further reinforcement model defined by the merged first and second model parameters to identify target matches within unlabelled data sets.

25. The method according to any of claims 20 to 24, wherein the first and second model parameters are merged by computing a soft probability distribution at a temperature T according to:
$${\tilde{p}}_{i} ( c \vert x , {θ}^{i} ) = \frac{exp ( {z}_{i}^{C} / T )}{{\sum }_{j = 1}^{C} exp ( {z}_{i}^{j} / T )} , c ∈ Y$$
$${\tilde{p}}_{e} ( c \vert x , {θ}^{e} ) = \frac{exp ( {z}_{e}^{C} / T )}{{\sum }_{j = 1}^{C} exp ( {z}_{e}^{j} / T )} , c ∈ Y$$
where i denotes a branch index, i=0, . . . , m, θⁱ and θ^{e} are the parameters of a branch and teacher model, respectively.

26. The method according to claim 25 further comprising the step of aligning model representations between branches using a Kullback Leibler divergence defined by:
$${ℒ}_{kl} = {\sum }_{i = 0}^{m} {\sum }_{j = 1}^{C} {\tilde{p}}_{e} ( j / x , {θ}^{e} ) log \frac{{\tilde{p}}_{e} ( j / x , {θ}^{e} )}{{\tilde{p}}_{i} ( j / x , {θ}^{i} )} .$$

27. A data processing apparatus comprising a processor adapted to perform the steps of the method of claims 1 to 26.

28. A computer program comprising instructions, which when executed by a computer, cause the computer to carry out the method of claims 1 to 26.

29. A computer-readable medium comprising instructions, which when executed by a computer, cause the computer to carry out the method of claims 1 to 26.
